(19) United States
(12) Patent Application Publication
(10) Pub. No.: US 2010/0332661 A1
(43) Pub. Date: Dec. 30, 2010

(54) Computer System and Its Operation Information Management Method

(75) Inventor: Takashi Tameshige, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/709,283

(22) Filed: Feb. 19, 2010

(30) Foreign Application Priority Data
Jun. 25, 2009 (JP) 2009-150724

(51) Int. Cl. G06F 15/173

(52) U.S. Cl. 709/226; 709/223

(57) ABSTRACT

Even if software resources for a physical server are changed, log information about the physical server can be accurately matched against the software resources.

If the need arises to migrate business applications in a physical server (migration source), from among a plurality of physical servers, to another physical server (migration destination), a management server collects log information, which has been collected by the migration source physical server, from the migration source physical server, collects identifiers for identifying the business applications at the migration source, and records the collected identifiers in the collected log information. Subsequently, when the business applications are migrated to the migration destination physical server, the management server records the identifiers for identifying the business applications in log information about the migration destination physical server.

### CROSS-REFERENCES TO RELATED APPLICATIONS

This application relates to and claims priority from Japanese Patent Application No. 2009-150724, filed on Jun. 25, 2009, the entire disclosure of which is incorporated herein by reference.

### BACKGROUND

1. Field of the Invention

The present invention relates to a technique enabling accurate matching of the content of logs in which information about operation of software such as its performance, failures, and system configuration when the software operates on a plurality of physical servers.

2. Description of Related Art

In recent years, along with the expansion of the blade server market and the virtual server market, it has become possible to migrate tasks from one server to another server with different performance by migrating tasks such as business applications to another server and have them operate on that server or migrating virtual servers in operation to a virtualization mechanism operating on another physical server.

There is a system that is suggested for use in the above-described case and is designed so that every time virtual servers are to be migrated from a physical server to another physical server, a management server records a migration history including migration time, virtual server identifiers, an identifier of the migration source physical server, and an identifier of the migration destination physical server (see Japanese Patent Laid-Open (Kokai) Application Publication No. 2007-323244).

### SUMMARY

As described above, it is possible to migrate a physical server for operating tasks, using the known technique. When doing so, logs that are operation information are set separately for each hierarchy (physical servers, a virtualization mechanism, virtual servers, OS, business applications), and time is set as an identifier common to logs for physical servers and logs for other hierarchies. In other words, if a task always operate on the same physical server, it is only necessary to refer to just logs for the single physical server. Therefore, since all you have to do is to refer to only the logs for the single physical server, the logs for the task can be matched against the logs for the physical server based on the time which is the only clue.

Meanwhile, the technique disclosed in Japanese Patent Laid-Open (Kokai) Application Publication No. 2007-323244 mentioned above focuses attention on the case of migration of virtual servers between a plurality of physical servers; and when virtual servers are migrated, information including time as an identifier can be traced by establishing a link to logs for the physical servers.

However, time is generally different for each physical server. Therefore, if time is used as an identifier, negative effects due to time adjustments, such as multiple transmissions of the same alert, may occur. If virtual servers are migrated in Japanese Patent Laid-Open (Kokai) Application Publication No. 2007-323244 where time is used as the identifier, logs for the task cannot be matched accurately against logs for the physical servers.

The present invention was devised in light of the above-described problems of the related art. It is an object of this invention to provide a computer system and computer system operation information management method that enable accurate matching of log information about physical servers against software resources even if the software resources for the physical servers are changed.

In order to achieve the above-described object, the invention is characterized in that when a management server serves to manage a plurality of physical servers for operating at least one software resource and collecting log information, the management server treats a change of any software resource from among the software resources as a trigger event, stores an identifier of identifying the relevant software resource, which operates on a physical server in which the change is made to its software resource (“change source physical server”), from among the physical servers, in log information about the change source physical server on which the software resource operates, and then treats the completion of the change as a trigger event and records the identifier in log information about another physical server.

Even if software resources for physical servers are changed, it is possible to accurately match log information about the physical servers against the software resources according to this invention.

### BRIEF DESCRIPTION OF THE DRAWINGS

FIG. 1 is a system configuration diagram showing the first embodiment of the present invention;

FIG. 2 is a configuration diagram showing the configuration of a management server;

FIG. 3 is a configuration diagram showing the configuration of a physical server;

FIG. 4 is a configuration diagram showing the configuration of a BMC;

FIG. 5 is an explanatory diagram for explaining the outline of actions of a system construction method;

FIG. 6 is a configuration diagram showing the configuration of another BMC;

FIG. 7 is a configuration diagram showing the configuration of another physical server;

FIG. 8 is a system configuration diagram showing the configuration of a blade server;

FIG. 9 is a configuration diagram showing the configuration of a service processor;

FIG. 10 is a configuration diagram showing the configuration of a blade server;

FIG. 11 is a configuration diagram of a physical server management table;

FIG. 12 is a configuration diagram of a virtualization mechanism management table;

FIG. 13 is a configuration diagram of a virtual server management table;

FIG. 14 is a configuration diagram of an OS management table;

FIG. 15 is a configuration diagram of a task management table;

FIG. 16 is a configuration diagram of a system management table;

FIG. 17 is a configuration diagram of a trigger event management table;

FIG. 18 is a configuration diagram of a marking rule management table;

FIG. 19 is a configuration diagram of an accounting information management table;

FIG. 20 is a flowchart for explaining a processing sequence executed by a trigger event monitor;

FIG. 21 is a flowchart for explaining a processing sequence executed by a log acquisition command unit;

FIG. 22 is a flowchart for explaining a processing sequence executed by a marking command unit;

FIG. 23 is a configuration diagram of a virtual server;

FIG. 24 is a flowchart for explaining a processing sequence executed by a log collector;

FIG. 25 is a flowchart for explaining a processing sequence executed by a tendency analyzer; and

FIG. 26 is a flowchart for explaining a processing sequence executed by a system configuration suggesting unit.

### DETAILED DESCRIPTION OF PREFERRED EMBODIMENTS

This embodiment is designed so that when a management server serves to manage a plurality of physical servers for operating software resources and collecting log information, the management server treats a change of any software resource, such as business applications, an OS (Operating System), virtual servers, and a virtualization mechanism, as a trigger event, stores an identifier for identifying the relevant software resource operating on a change source physical server in which the change is made to its software resource, from among the physical servers, in log information about the change source physical server on which the relevant software resource operates, and then treats the completion of the change as a trigger event and records the identifier in log information about another physical server.

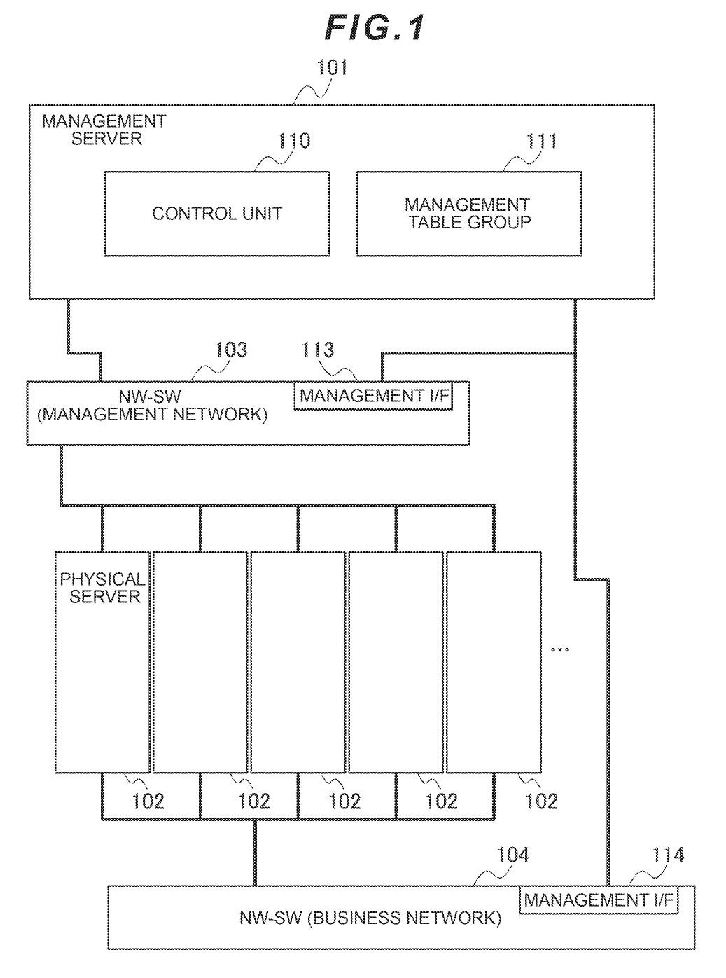

FIG. 1 is a configuration diagram of a computer system according to the first embodiment. Referring to FIG. 1, the computer system includes a management server 101 and a plurality of physical servers 102 and the management server 101 and each physical server 102 are connected via an NW-SW (Network-Switch management network) 103 and an NW-SW 104.

The management server 101 is connected to a management interface (management I/F) 113 for the NW-SW 103 and to a management interface 114 for the NW-SW (task network) 104, and it is possible to set a VLAN (Virtual Local Area Network) for each NW-SW 103, 104 from the management server 101.

The NW-SW 103 is a management network that is needed in order to operate and manage each physical server 102 by means of, for example, delivery and power source control of an OS and applications. The NW-SW 104 belongs to a network for tasks and is a network used by task applications executed on each physical server 102.

Processing is executed by a control unit 110 on the management server 101 and reference to a management table group 111 is made and the management table group 111 is updated as a result of the processing executed by the control unit 110.

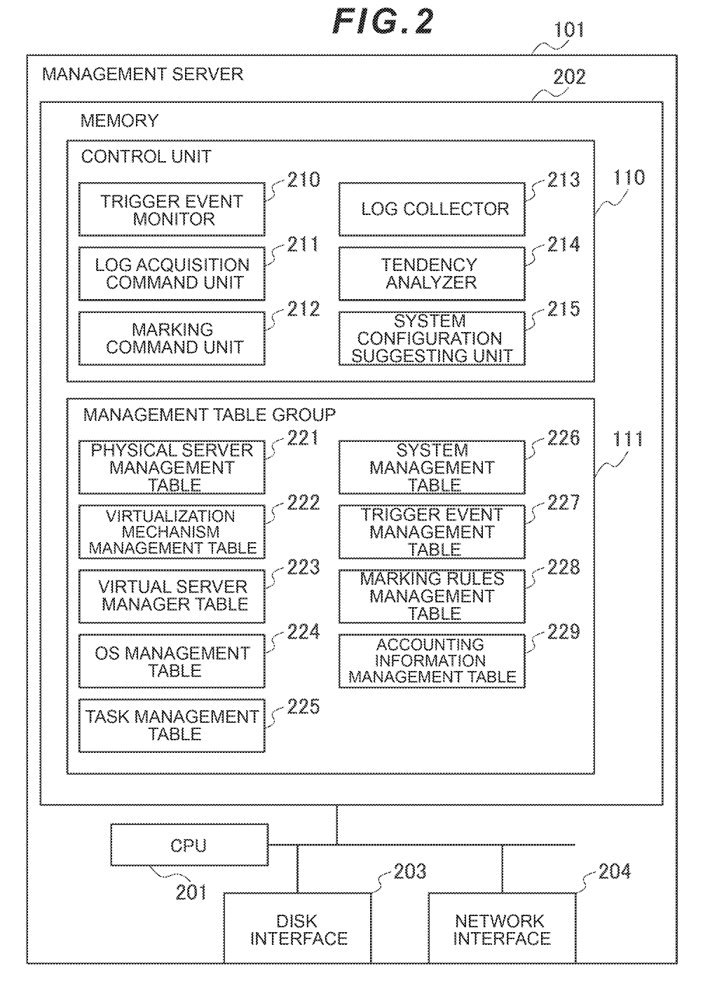

FIG. 2 shows the configuration of the management server 101. The management server 101 is constituted from a CPU (Central Processing Unit) 201 for processing arithmetic operations, a memory 202 for storing programs operated by the CPU 201 and data relating to execution of the programs, a disk interface 203 with a storage apparatus for storing programs and data, and a network interface 204 for communication via an IP (Internet Protocol) network.

FIG. 2 shows one network interface 204 and one disk interface 203 to represent a plurality of network interfaces 204 and disk interfaces 203, respectively. Therefore, the management server 101 can use different network interfaces 204 for connection with, for example, the management network 103 and the task network 104, respectively.

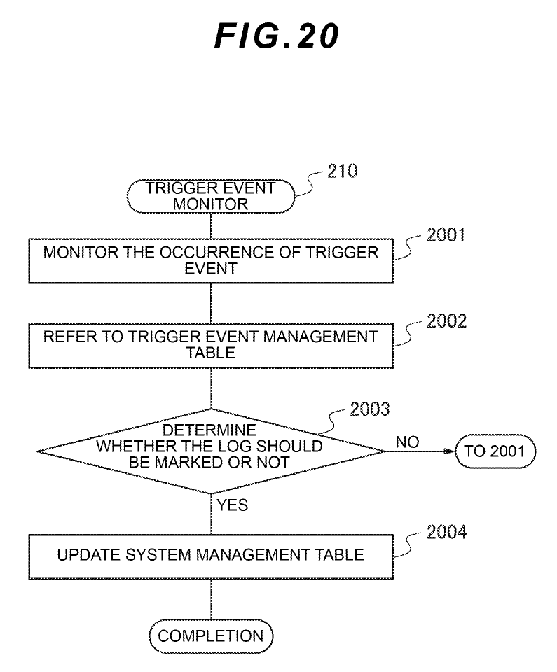

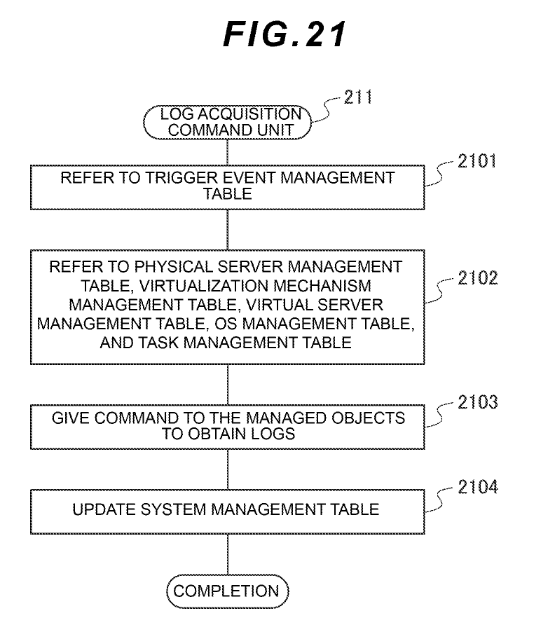

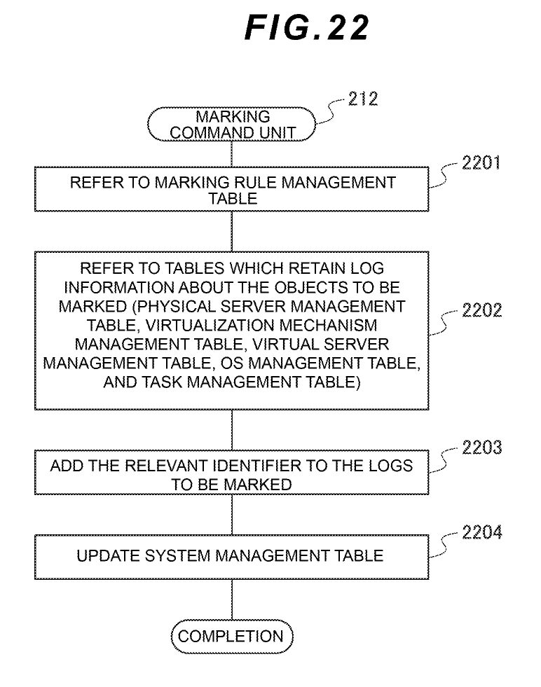

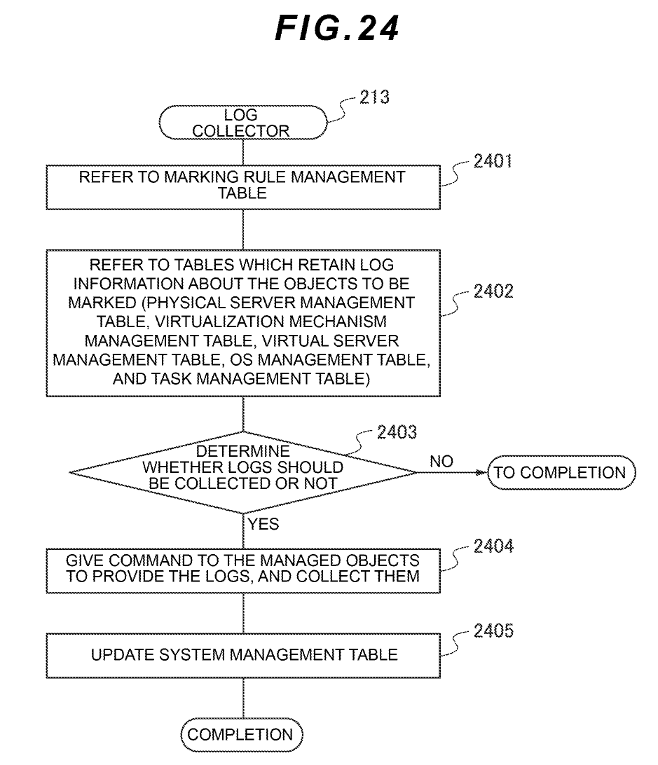

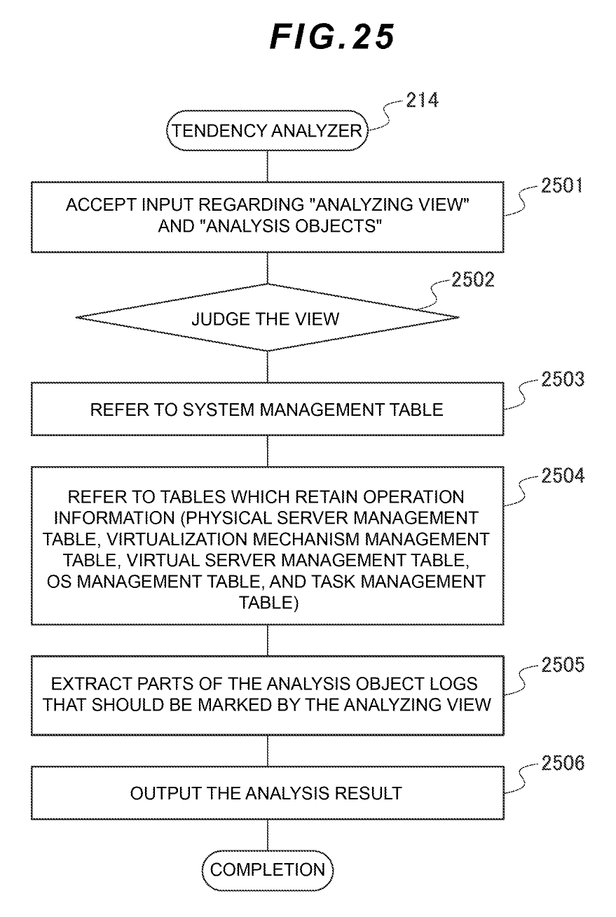

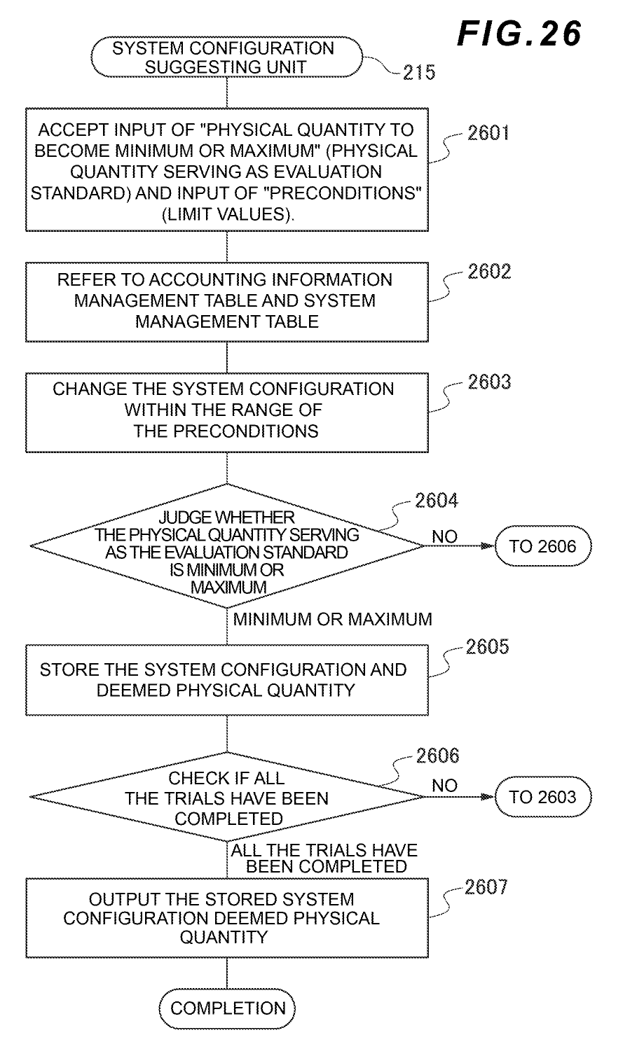

The memory 202 stores the control unit 110 and the management table group 111. The control unit 110 includes a trigger event monitor 210 (see FIG. 20), a log acquisition command unit 211 (see FIG. 21), a marking command unit 212 (see FIG. 22), a log collector 213 (see FIG. 24), a tendency analyzer 214 (see FIG. 25), and a system configuration suggesting unit 215 (see FIG. 26).

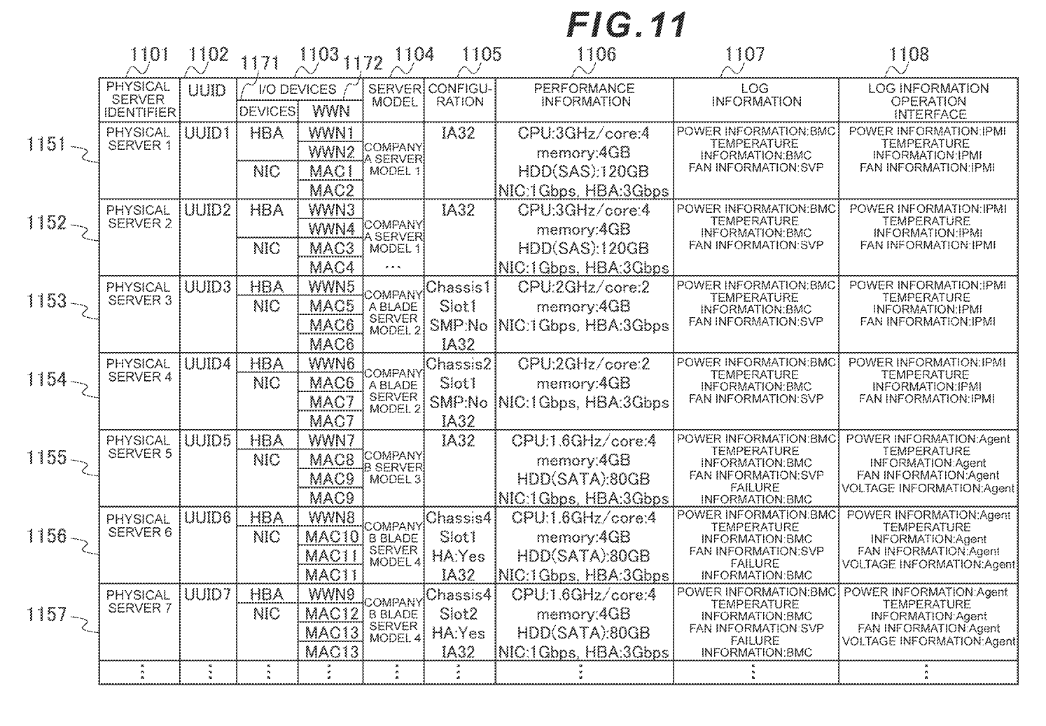

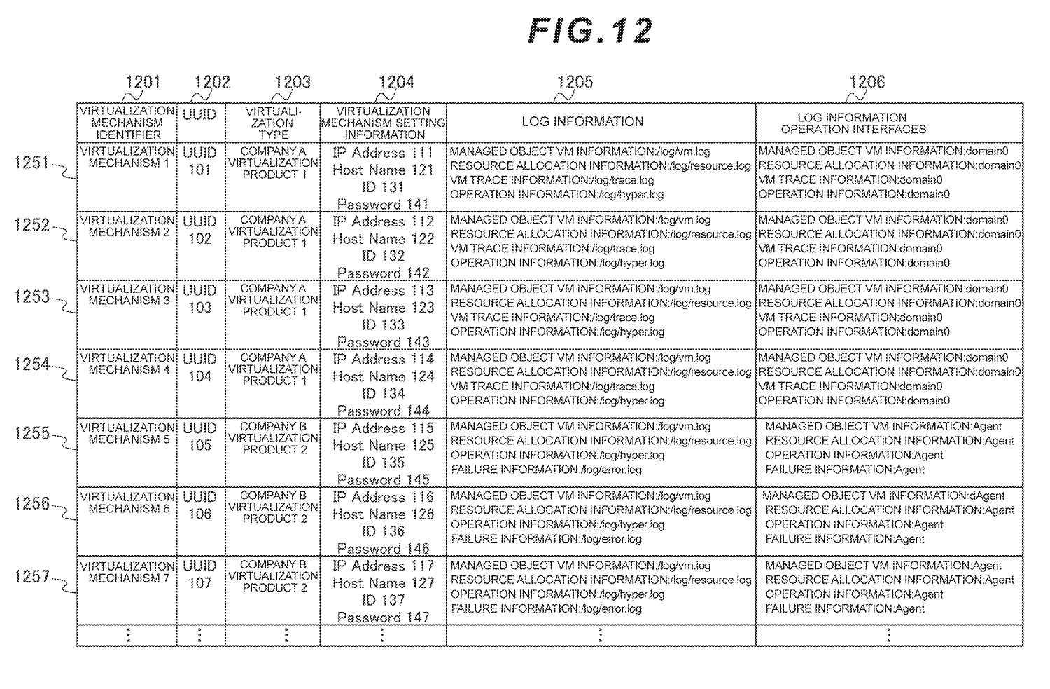

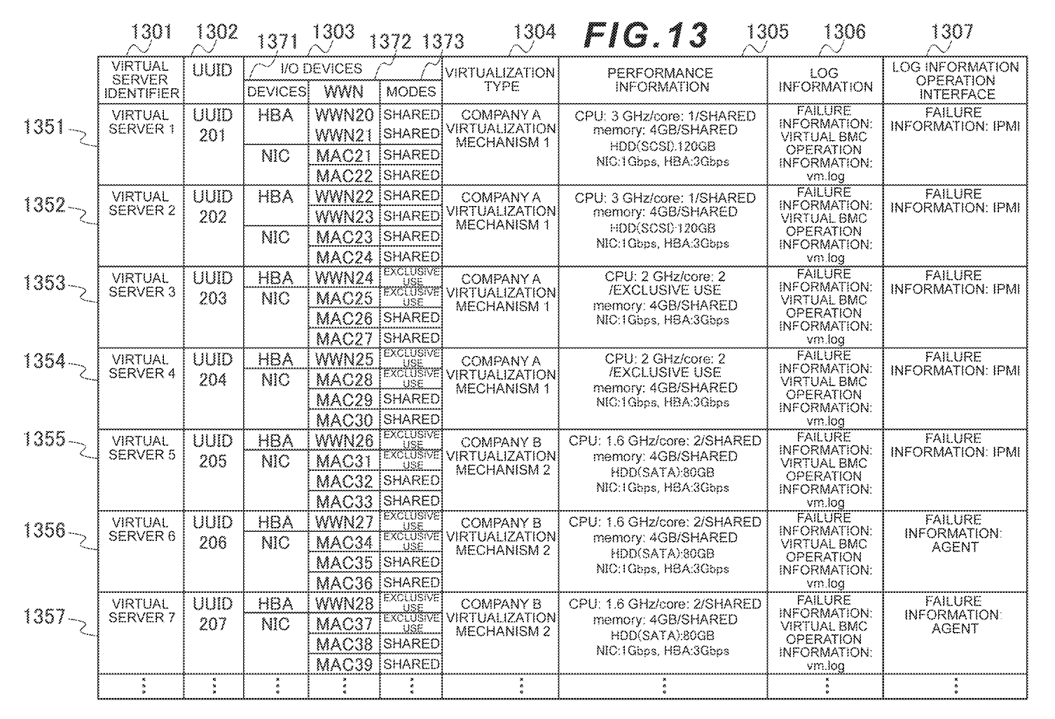

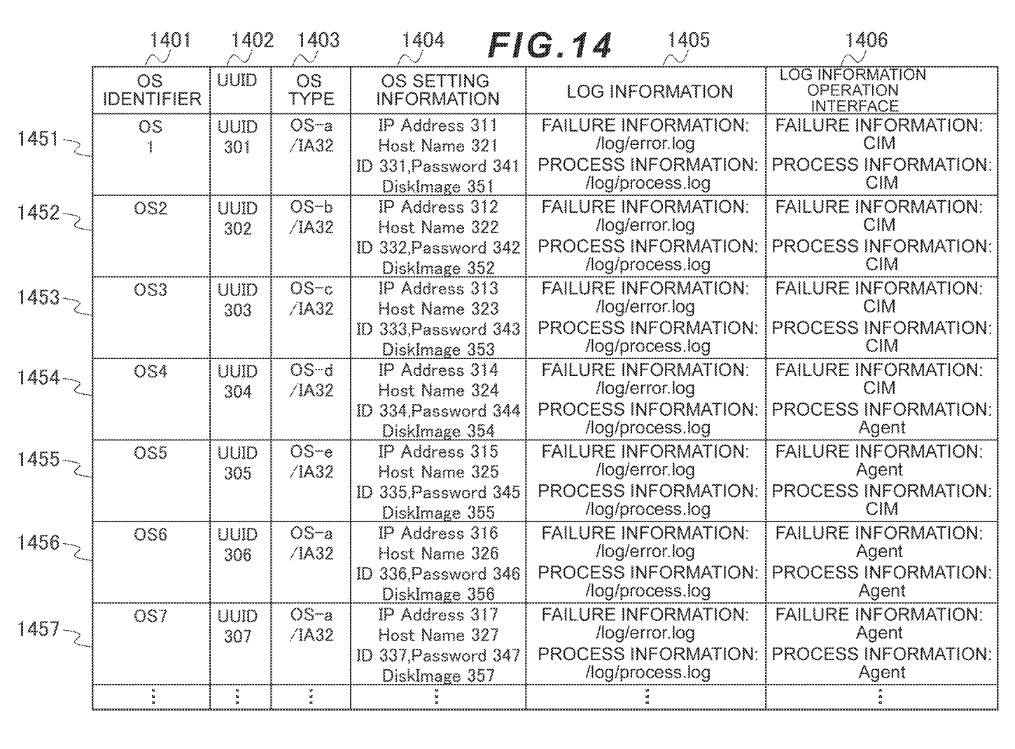

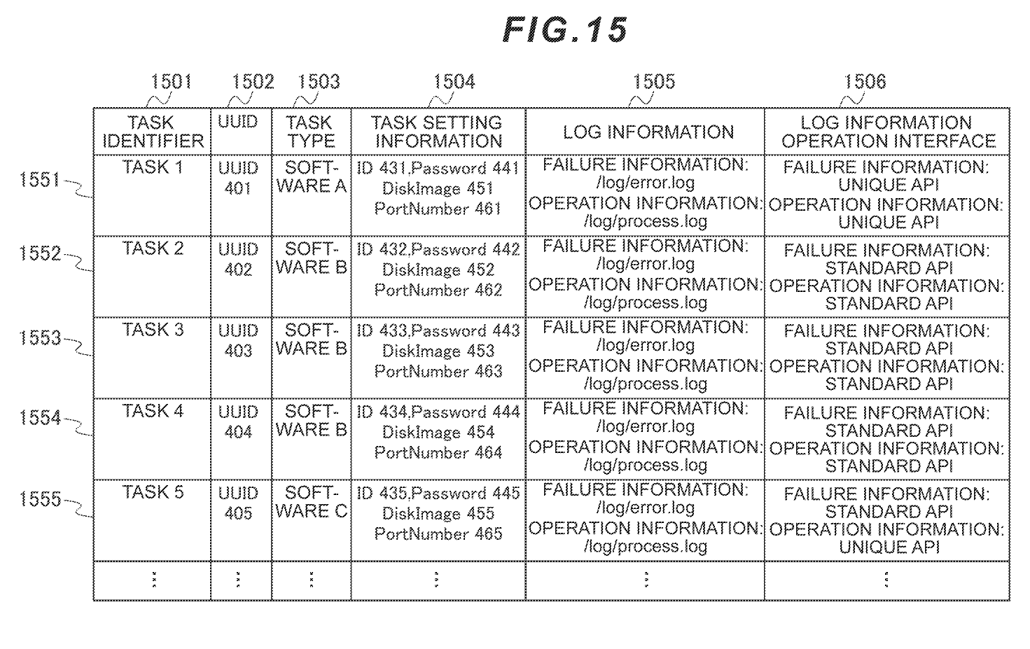

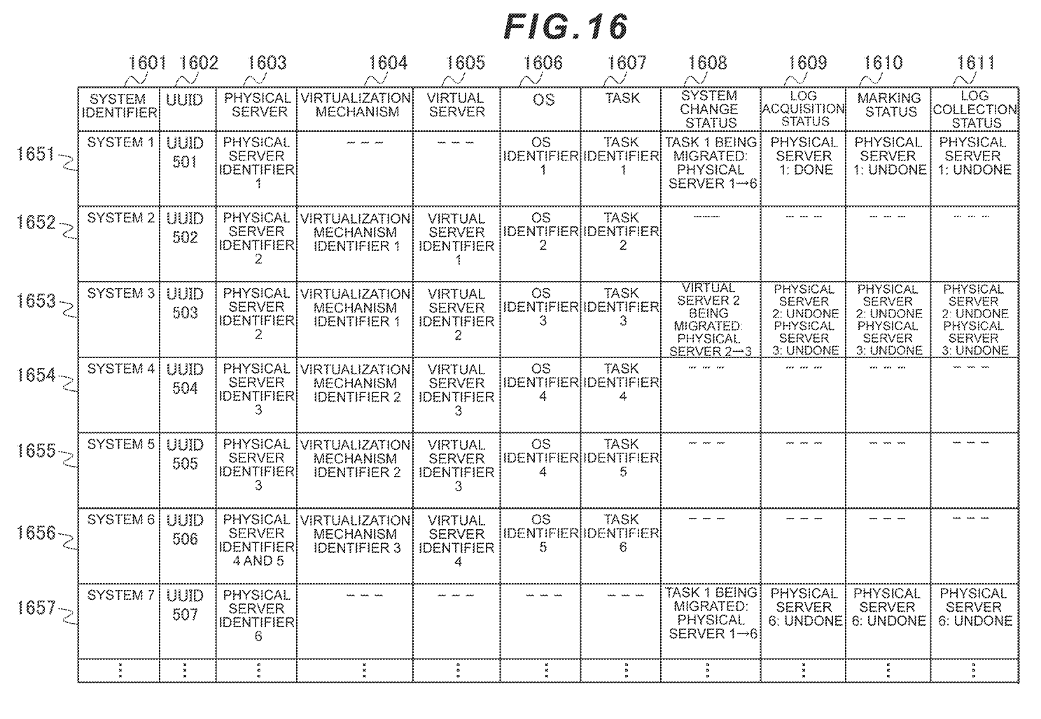

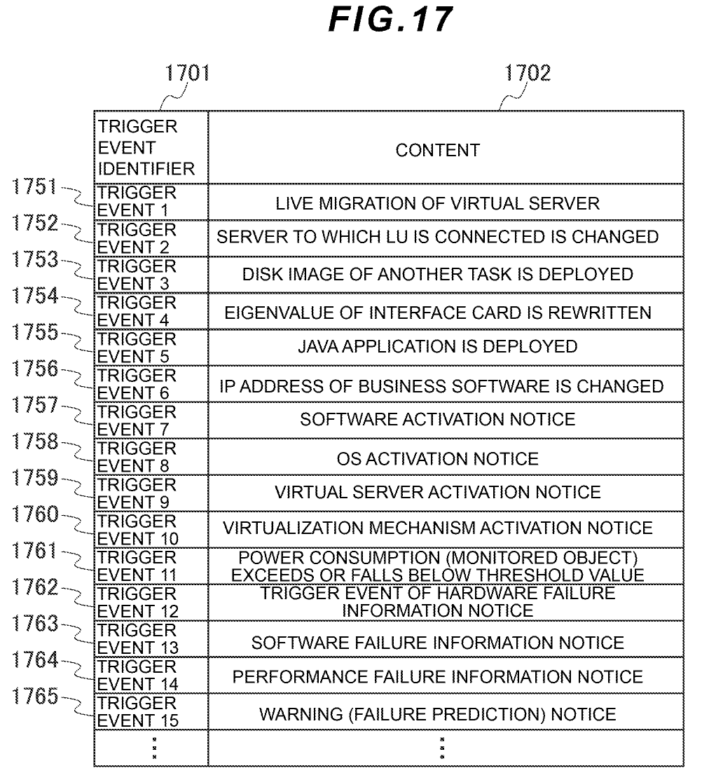

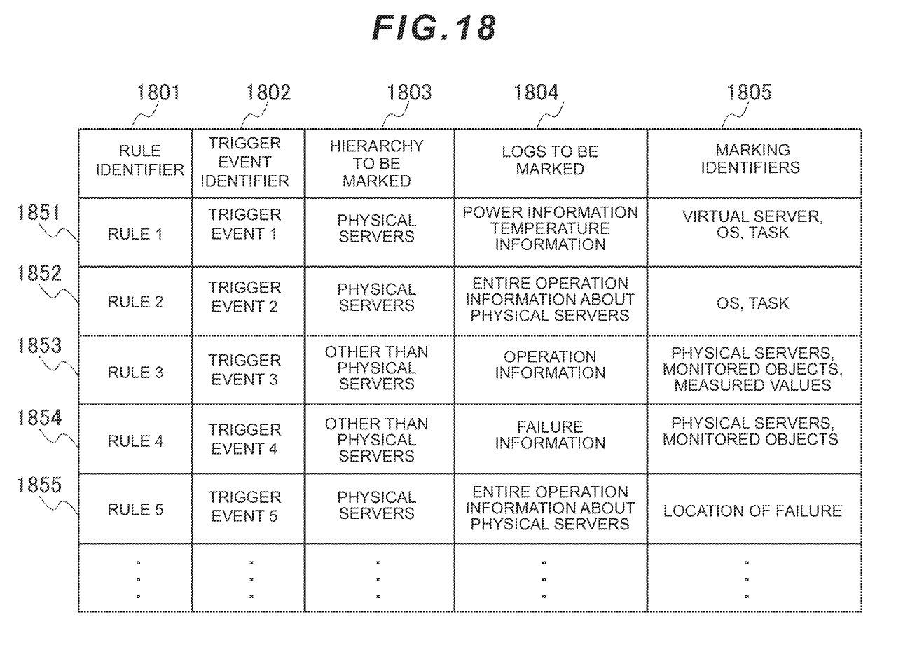

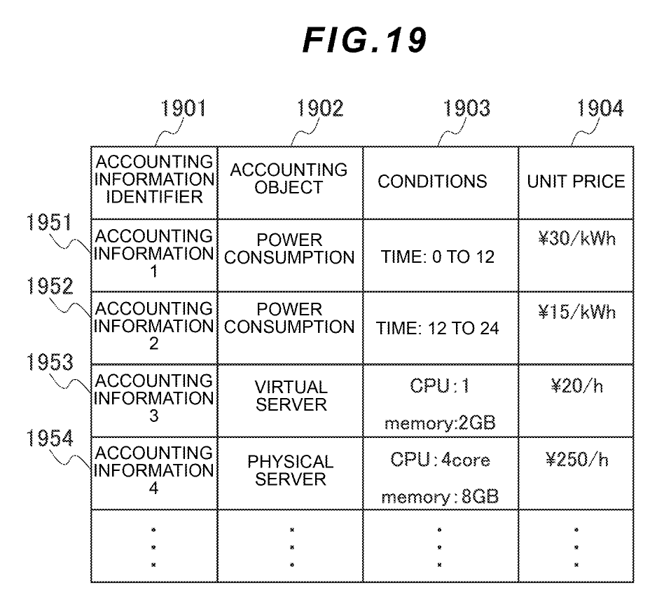

The management table group 111 includes a physical server management table 221 (see FIG. 11), a virtualization mechanism management table 222 (see FIG. 12), a virtual server management table 223 (see FIG. 13), an OS management table 224 (see FIG. 14), a task management table 225 (see FIG. 15), a system management table 226 (see FIG. 16), a trigger event management table 227 (see FIG. 17), a marking rule management table 228 (see FIG. 18), and an accounting information management table 229 (see FIG. 19).

Information for each table may be automatically collected by means of standard interfaces or information collection programs or manually input by users. However, information such as rules and policies, except those for which limit values are set due to physical requirements or requirements of laws, needs to be input in advance by the users. In this case, it is necessary to provide an input interface. If the computer system is operated within the range not reaching the limit values, it is also necessary to provide an interface for inputting conditions.

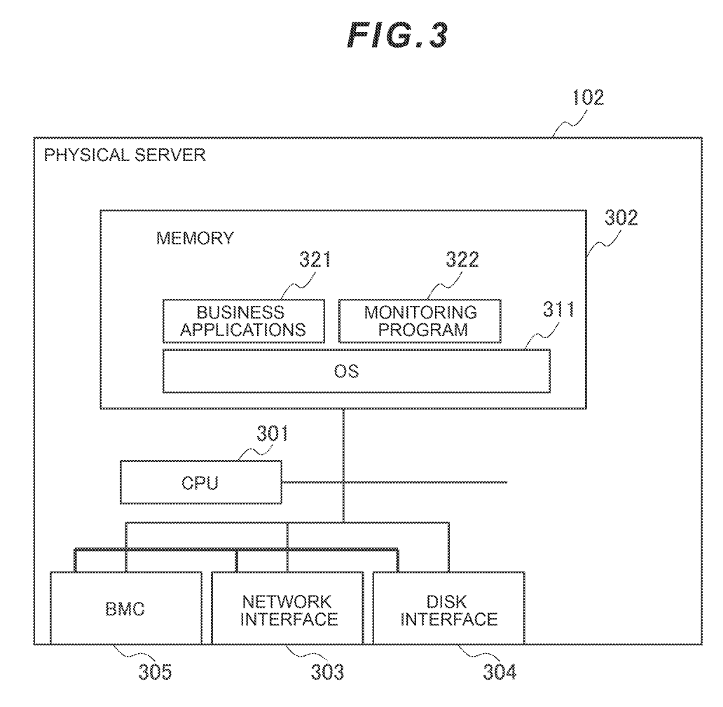

FIG. 3 shows the configuration of the physical server 102. The physical server 102 includes a CPU 301 for processing arithmetic operations, a memory 302 for storing programs operated by the CPU 301 and data relating to execution of the programs, a disk interface 304 for exchanging information with a storage apparatus storing programs and data, a network interface 303 for external communication via an IP network, and a BMC (Baseboard Management Controller) 305 for power supply control of the CPU 301 and control of each interface 303, 304.

The memory 302 stores, as software resources, a monitoring program 322, a business application 321, and an OS 311 as well as virtual servers and a virtualization mechanism as described later. The virtualization mechanism is obtained by virtualizing, for example, the CPU 301 which is a hardware resource for the physical server 102. The virtual servers are servers virtualized by the virtualization mechanism. The OS 311 operates on the virtual servers, and the virtual servers operate on the virtualization mechanism.

In this physical server 102, the OS 311 in the memory 302 is executed by the CPU 301 and the application 321 for providing tasks and the monitoring program 322 operate under the control of the OS 311. In this situation, the physical server 102 collects log information, which is physical operation information, such as power information including power consumption, voltage information, temperature information including environment temperatures, and fan information including the number of revolutions of electric fans, from monitored objects in accordance with the application 321 and the monitoring program 322.

FIG. 3 shows one network interface 303 and one disk interface 304 to represent a plurality of network interfaces 303 and disk interfaces 304, respectively. Therefore, the physical server 102 can use different network interfaces 303 for connection with, for example, the management network 103 and the task network 104, respectively.

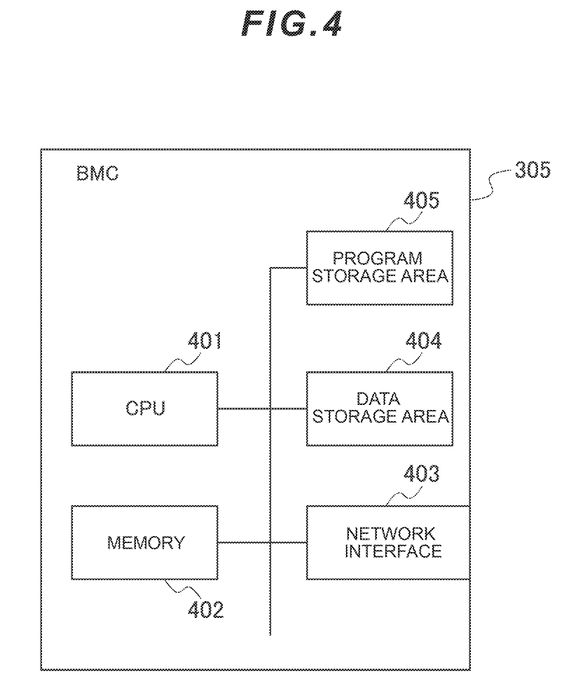

FIG. 4 shows the configuration of the BMC 305. The BMC 305 includes a CPU 401 for processing arithmetic operations, a memory 402 for storing data relating to the arithmetic operations by the CPU 401, a network interface 403 for external communication via an IP network, a data storage area 404 for storing data before and after the arithmetic operations by the CPU 401, and a program storage area 405 for storing programs used for the arithmetic operations by the CPU 401.

The BMC 305 is often equipped with only functions that are designed for specific use, but it is possible to construct a mechanism for adding log information to the BMC 305 the log information. For example, the mechanism for adding log information to the BMC 305 can be constructed when updating firmware by adding a log information adding function to the programs stored in the program storage area 405.

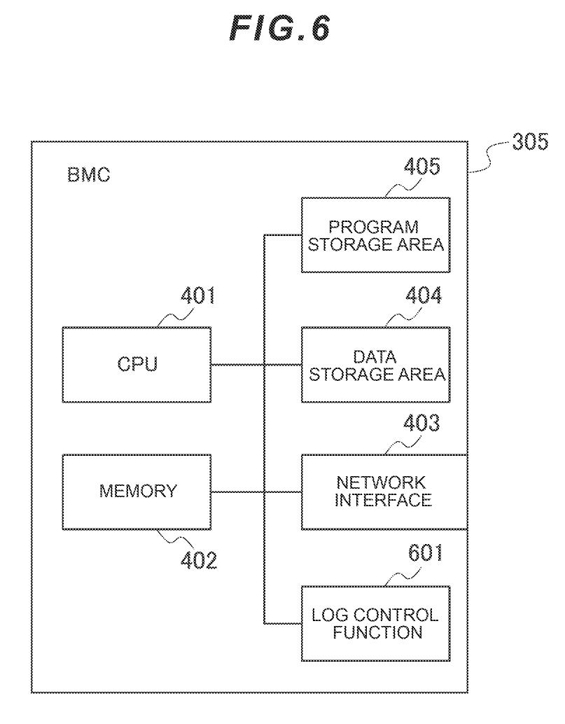

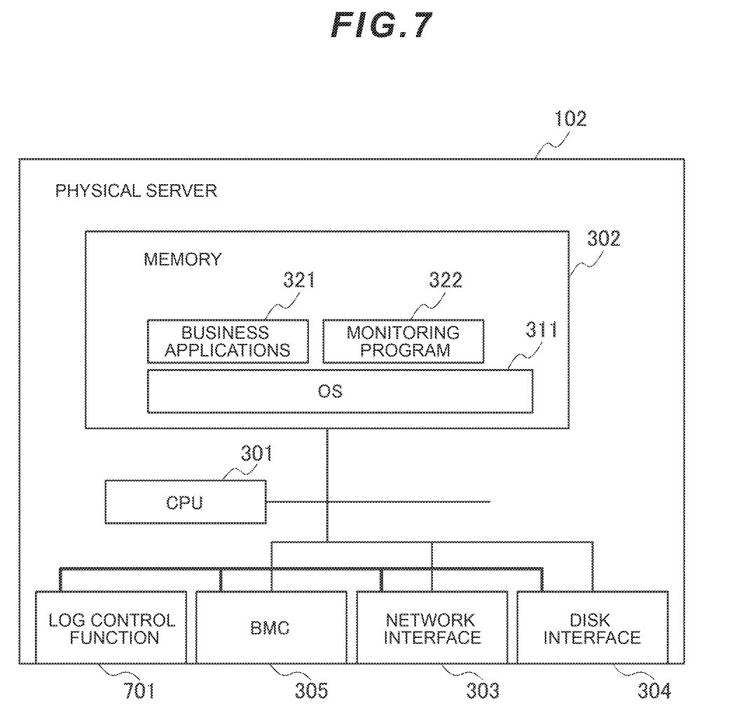

Incidentally, if a conventional BMC 305 continues to be used or a BMC 305 whose control interface is not made public is used, the mechanism for adding the log information can be constructed as shown in FIG. 6 or 7 by adding devices in terms of hardware inside and outside the BMC 305, for example, devices having a CPU for collecting log information according to programs.

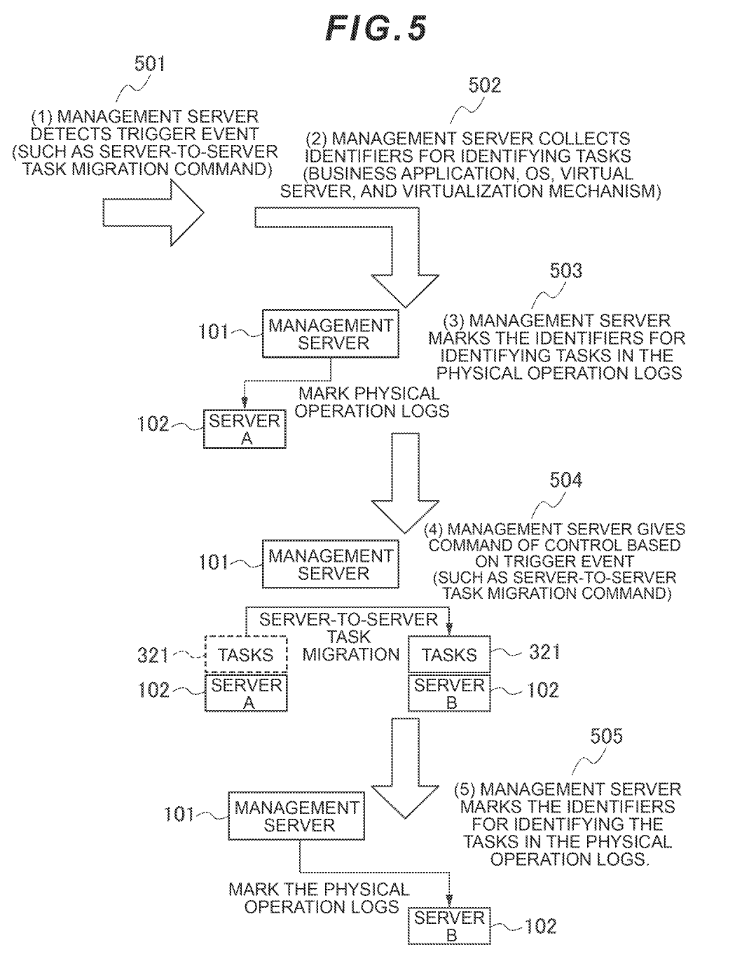

FIG. 5 shows the outline of actions of a system operation information management method. Firstly, (1) the management server 101 starts processing caused by a change of the software resource as triggered by a trigger event 501 which is periodic monitoring or event (such as a server-to-server task migration command.

(2) Next, if at least one of the software resources (the business application 321, the OS 311, the virtual server, and the virtualization mechanism) is changed, for example, if a change is made to migrate the active business application 321 to another physical server, the management server 101 extracts the change source or migration source physical server 102, in which the change is made to its software resource or from which the business application 321 is migrated, from among a plurality of physical servers 102, collects log information (physical operation log), such as power information, which has been collected by the migration source physical server 102, from the extracted migration source physical server 102, and also collects an identifier for identifying the active business application 321 operating on the migration source physical server 102, for example, the IP address that is unique to the relevant computer system (502).

When this happens, the management server 101 can keep a record of the pre-migration state of the business application 321 in the log information by acquiring both the identifier and the power information at the same time. According, the operation information can be mapped with a high degree of accuracy.

(3) The management server 101 records (marks), for example, the IP address, as the collected identifier in the collected power information (503).

(4) Next, the management server 101 gives a command to the migration source physical server 102 and the migration destination physical server (the other physical server) 102 to be controlled as triggered by the trigger event 501. As a result, the active business application 321 operating on the migration source physical server (server A) 102 is migrated to the migration destination physical server (server B) 102.

(5) Subsequently, the management server 101 records (marks) the identifier, such as the IP address, for identifying the business application 321 in the log information (physical operation log), such as the power information, about the migration destination physical server (server B) 102 and keeps a record of the fact that the business application 321 has been migrated to the migration destination physical server (server B) 102, as the log information.

As a result, for example, an observable physical quantity such as electric energy which is the power information from among the software resources (the business application 321, the OS 311, the virtual server, and the virtualization mechanism) can be found accurately.

Regarding the operation information used by the business application 321 and the virtual server, the OS 311 and the virtualization mechanism precisely recognize it as operation information or allocation information. Therefore, it is possible to calculate the physical quantity used by a specific business application or a specific virtual server by prorating the entire quantity used by the specific business application and the specific virtual server between the specific business application and the specific virtual server and accurately matching the prorated quantity against the log information which has been recorded as physical operation information realized according to the present invention. As a result, for example, power consumption for each task can be found.

While the management server 101 monitors the physical quantity (such as electric energy) acquired by each physical server 102 and its threshold value (kW), the management server 101 recognizes, as a trigger event, when the physical quantity (such as electric energy) acquired by each physical server 102 exceeds or falls below the threshold value, for example, when the electric energy exceeds the threshold value or the electric energy falls below the threshold value; and it is thereby possible to recognize the business application 321 and the virtual server which are active at that time.

Specifically speaking, the management server 101 collects log information from each physical server 102; and if any piece of the collected log information exceeds or falls below the predetermined threshold value, the management server 101 recognizes such event as a trigger event and can record the identifier for specifying active software resources operating to collect the log information which has exceeded or fallen below the threshold value, or record the log information which has exceeded or fallen below the threshold value, in the log information about the physical server 102 in which the log information exceeding or falling below the threshold value is collected, from among a plurality of physical servers 102. As a result, it is possible to recognize the accurate log information (task operation log) from a physical point of view.

In this situation, it is possible to create a plan to migrate the physical server 102, whose acquired physical quantity has exceeded or fallen below the threshold value, to another physical server, chassis (in the case of blade servers), rack, breaker, floor, or center.

When marking (recording) the identifier in the log information, the following advantages are brought about by marking the occurrence of failures such as hardware failures, software failures, and performance failures as trigger events and marking failure predictions and performance failure predictions.

Specifically speaking, if a hardware failure is recognized as a trigger event and software information (such as an identifier) is marked in a hardware log, it is possible to judge which software should be recovered.

If a software failure is recognized as a trigger event and hardware information (such as an identifier) is marked in a software log, it is possible to judge whether the failure was caused by the depletion of physical computer resources or not.

If a software failure is recognized as a trigger event and the software information (such as an identifier) is marked in the hardware log, it is possible to specify whether or not the failure was caused by a user program in the environment using the virtual server. As a result, it is possible to carry out the following strict operation: if the failure was caused by a user, the user will be charged; and if the failure was caused by the computer environment, the user will not be charged. In other words, risks can be diversified properly.

If a performance failure is recognized as a trigger event and the hardware information (such as an identifier) is marked in the software log, it is possible to judge how much the physical computer resources have been depleted. If the physical computer resources have not been depleted, it is possible to determine that it is only necessary to implement measures in the hierarchy higher than the virtualization mechanism.

If a performance failure is recognized as a trigger event and the software information (identifier) is marked in the hardware log, it is possible to specify which and how many tasks (software resources) are active. As a result, it is possible to adjust a combination of tasks, which are to be placed together in the same server, and take measures to prevent the performance failure. It is also possible to take a measure to save the tasks to another server in order of priority of the tasks.

If a failure prediction is recognized as a trigger event and the hardware information (such as an identifier) is marked in the software log, it is possible to take a measure to migrate tasks to another server before a system down occurs due to the failure by monitoring the software log. If the temperature is abnormal, it is possible to judge that the temperature around the relevant physical server, and to take measures to migrate the physical server to another rack or floor or acquire temperatures around the physical server and then decide a migration destination.

If a failure prediction is recognized as a trigger event and the software information (identifier) is marked in the hardware log, it is possible to specify which and how many tasks are active. As a result, it is possible to set the order of saving priority based on the priorities of the tasks and easiness of migration and thereby take a measure to continue the higher priority tasks with a high probability.

If a performance failure prediction is recognized as a trigger event and the hardware information (such as an identifier) is marked in the software log, it is possible to judge which physical computer resource has been depleted and how much the depletion has been. If the physical computer resources have not been depleted, it is possible to determine that it is only necessary to implement measures in the hierarchy higher than that of the virtualization mechanism.

If a performance failure prediction is recognized as a trigger event and the software information (identifier) is marked in the hardware log, it is possible to specify which and how many tasks are active. As a result, it is possible to adjust a combination of tasks, which are to be placed together in the same server, and take measures to prevent the performance failure. It is also possible to take a measure to save the tasks to another server in order of priority of the tasks.

FIG. 6 shows a different embodimen of the BMC 305. This BMC 305 is similar to the BMC 305 shown in FIG. 4, except that it has a log control function 601. The log control function 601 has a function marking logs (log information) stored in a data storage area 404. Incidentally, it is possible to add, to the log control function 601, a function collecting logs from the data storage area 404, marking the collected logs, and then either storing data in the log control function 601 or sending the collected logs to the management server 101.

Since the BMC 305 shown in FIG. 6 is the embodiment that can be realized by adding hardware to the BMC 305 shown in FIG. 4 and past assets can be diverted for the above-described use, it is possible to realize it at low cost. If it is necessary due to requirements of, for example, laws and regulations to store the logs without adding anything to them and the added hardware is to be removed, a realization method of keeping the original log in the data storage area 404 is possible.

FIG. 7 shows a different embodiment of the physical server 102. A log control function 701 has a function marking logs stored in the BMC 305. Incidentally, it is possible to add, to the log control function 701, a function collecting logs from the BMC 305, marking the collected logs, and then either storing data in the log control function 701 or sending the collected logs to the management server 101.

In the same manner as in the embodiment of the BMC 305 in FIG. 6, the physical server 102 shown in FIG. 7 can be realized at low cost by diverting past assets for the above-described use, it is possible to realize it at low cost. Even if a function similar to the log control function 701 is realized by the management server 101, a similar effect can be obtained.

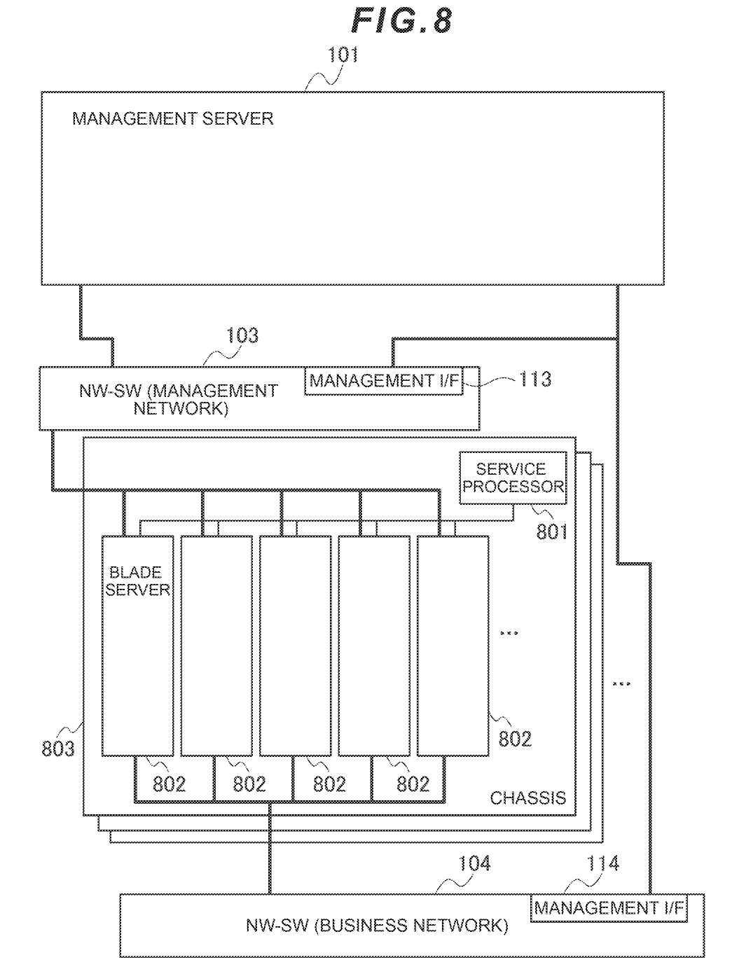

FIG. 8 is a configuration diagram of a computer system that uses, instead of a plurality of physical servers, a plurality of blade servers 802 having almost the same functions as those of the physical servers and in which each blade server 802 is connected to a service processor 801.

The management server 101 is connected to the service processor 801 and each blade server 802 for a chassis 803 via an NW-SW (management network) 103. The service processor 801 is connected to the blade servers 802 via an internal network. The management server 101 is connected to the management interface (management I/F) 113 for the NW-SW 103 and to the management interface 114 for the NW-SW (task network) 104, and it is possible to set a VLAN (Virtual LAN) for each NW-SW from the management server 101.

The service processor 801 detects insertion or removal of a blade server 802 into or from the chassis 803 (addition or deletion of the blade server 802) and a failure of the blade server(s) 802 and notifies the management server 101 of an alert.

The NW-SW 103 is a management network which is necessary to operate and manage the blade servers 802 by means of, for example, delivery and power source control of an OS and applications. The NW-SW 104 belongs to a network for tasks and is a network used by task applications executed on each blade server 802.

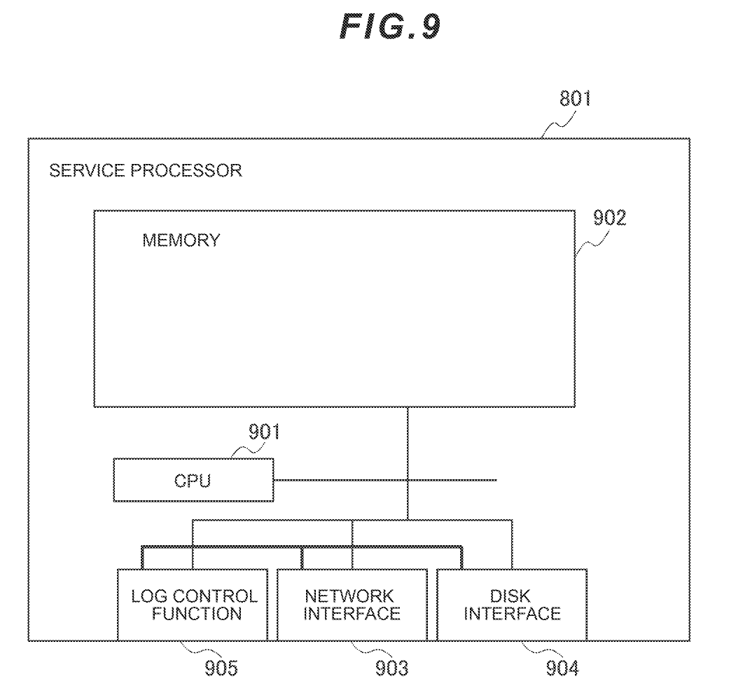

FIG. 9 shows the configuration of the service processor 801. Referring to FIG. 9, the service processor 801 is constituted from a CPU 901 for processing arithmetic operations, a memory 902 for storing programs operated by the CPU 201 and data relating to execution of the programs, a disk interface 904 with a storage apparatus for storing programs and data, a network interface 903 for external communication via an IP network, and a log control function 905 having a function that controls logs.

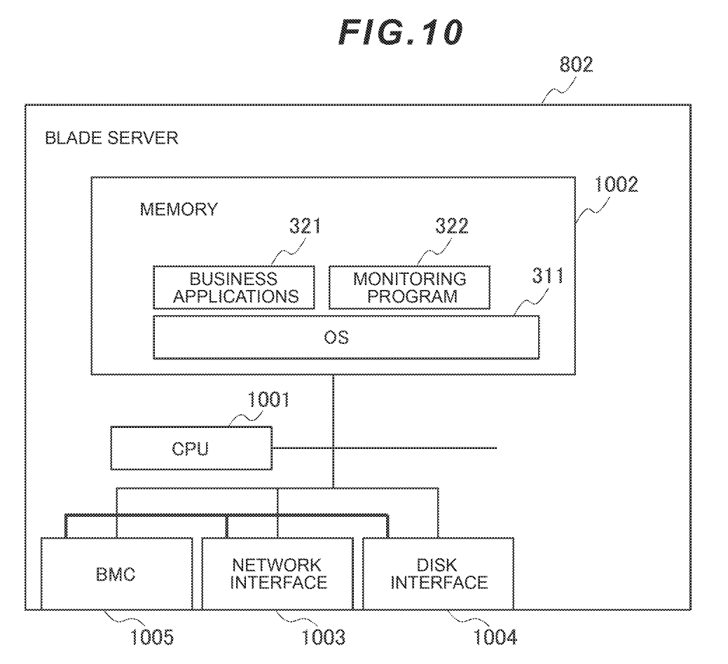

However, if the log control function 905 is realized in the blade server 802 or in a BMC 1005 (see FIG. 10) for the blade server 802 by the management server 101, it is not always necessary to have the log control function 905.

FIG. 10 shows the configuration of the blade server 802. Referring to FIG. 10, the blade server 802 includes a CPU 1001 for processing arithmetic operations, a memory 1002 for storing programs operated by the CPU 1001 and data relating to execution of the programs, a disk interface 1004 with a storage apparatus storing programs and data, a network interface 1003 for external communication via an IP network, and a BMC (Baseboard Management Controller) 1005 for power supply control and control of each interface.

As the OS 311 on the memory 1002 is executed by the CPU 1001, the blade server 802 manages devices in the blade server 802. The business application 321 for providing tasks and the monitoring program 322 operate under the control of the OS 311. The BMC 1005 is connected via an internal network to the service processor 801 and has a function reporting operation information and failure information and a function accepting and executing a power supply control command. Moreover, the blade server 802 according to this embodiment has a function obtaining, sending, and marking logs.

FIG. 11 shows a physical server management table 221. Referring to FIG. 11, a column 1101 in the physical server management table 221 for managing the physical servers 102 and the blade servers 802 stores a physical server identifier; and this identifier makes it possible to uniquely identify each physical server. Input of data to be stored in the column 1101 can be omitted by designating any of the columns used in this table 221 or a combination of the columns. Alternatively, the data may be automatically assigned, for example, in ascending order.

A column 1102 stores a UUID (Universal Unique IDentifier). The UUID is an identifier whose format is specified to avoid duplications. So, as the UUID is retained corresponding to each server 102 or 802, the UUID can be an identifier whose absolute uniqueness is guaranteed. Therefore, the UUID is an identifier candidate for the server identifiers stored in the column 1101 and is very effective in a wide range of server management.

However, any identifier by which a system administrator can identify the relevant server may be used in the column 1101 and there would be no problem unless there are any duplicate identifiers between different servers which are the managed objects. Therefore, it is desirable, but not indispensable, to use the UUID. For examples, a MAC address or a WWN (World Wide Name) can be used as the server identifier in the column 1101.

A column 1103 (a column 1171 and a column 1172) stores information about I/O devices. The column 1171 stores the device types. For example, an HBA (Host Bus Adaptor) and an NIC (Network Interface Card) are stored. A column 1172 stores a WWW (World Wide Name), which is the identifier of an HBA, and an MAC (Media Access Control) address which is the identifier of an NIC.

A column 1104 stores the model of the physical server 102. This model is information about infrastructure and information such as performance and configurable system limits relating to accounting and whether or not it is possible to migrate servers.

A column 1105 stores configuration information about the configuration of the physical server 102. For example, the column 1105 stores, as the configuration information about the configuration of the physical server 102, the architecture of a processor (CPU 301 or CPU 1001), physical position information about the chassis 803 and slots, and characteristic functions (whether a blade-to-blade SMP [Symmetric Multiprocessing] or HA [High Availability] configuration exists or not). The column 1105 is also information about infrastructure.

A column 1106 stores performance information about the physical server 102. The column 1106 is also information about infrastructure.

A column 1107 stores log information. This column 1107 stores information about logs, that is, what kind of information is stored in the logs and where the logs are stored.

A column 1108 stores information about interfaces for operating the log information. This information indicates what type of interface can control what type of information. Marking on the logs as realized by the present invention is enabled by using the information obtained from the column 1107 and the column 1108.

The information about infrastructure is necessary in order to judge whether migration is possible or not when a migration destination of the physical server 102 is to be suggested.

FIG. 12 shows a virtualization mechanism management table 222. The virtualization mechanism management table 222 is used to manage information about what kind of a virtualization mechanism is used, what kind of logs are stored, where the logs are stored, and how the logs can be accessed.

A column 1201 stores a virtualization mechanism identifier and this identifier makes it possible to uniquely identify each virtualization mechanism. Input of data to be stored in the column 1201 can be omitted by designating any of the columns used in this table 222 or a combination of the columns. Alternatively, the data may be automatically assigned, for example, in ascending order.

A column 1202 stores an UUID. The UUID is a strong candidate for the virtualization mechanism identifier.

A column 1203 stores the virtualization type. The virtualization type indicates a virtualization product or a virtualization technique and can clearly distinguish control interfaces or functional differences. Version information may be included. If the relevant virtualization mechanism has its own management function, the name of that management function and a management interface may be included.

A column 1204 stores virtualization mechanism setting information. The virtualization mechanism setting information is, for example, an IP address necessary for connection to the virtualization mechanism.

A column 1205 stores log information. The column 1205 stores information about what kind of information is retained as logs and where the logs are retained.

A column 1206 stores log information operation interfaces. The column 1206 stores information about programs and interfaces to be connected when operating logs.

Marking on the logs as realized by the present invention is enabled by using the information obtained from the column 1205 and the column 1206.

FIG. 13 shows a virtual server management table 223. The virtual server management table 223 is a table used to manage information about what kind of a system configuration is defined for the relevant virtual server, what kind of logs are stored, where the logs are stored, and how the logs can be accessed.

A column 1301 stores a virtual server identifier; and this identifier makes it possible to uniquely identify each virtual server.

A column 1302 stores a UUID. The UUID is a candidate for the virtual server identifier stored in the column 1301 and is very effective in a wide range of server management. However, any identifier by which the system administrator can identify the relevant server may be used in the column 1301 and there would be no problem unless there are any duplicate identifiers between different servers which are the managed objects. Therefore, it is desirable, but not indispensable, to use the UUID.

For example, a virtual MAC address or a virtual WWN (to be stored in a column 1372) may be used as the virtual server identifier in the column 1301. The OS 311 may sometimes adopt an identifier to maintain uniqueness; and in this case, the ID adopted by the OS 311 may be used as virtual server identifier in the column 1301 or the OS 311 may retains the ID by itself in order to secure uniqueness.

A column 1303 (from a column 1371 to a column 1373) stores information about virtual I/O devices. The column 1371 stores the virtual device type. It stores, for example, a virtual HBA and a virtual NIC. The column 1372 stores a virtual WWN, which is an identifier of the virtual HBA, and a virtual MAC address which is an identifier of the virtual NIC. The column 1373 stores virtual I/O device modes; and there are a shared mode and an exclusive use mode.

A virtual device(s) can operate in two modes: a mode in which a physical device is shared by a plurality of virtual devices; and a mode in which a physical device is used exclusively by a single virtual device. In the shared mode, other virtual devices also use the relevant physical device at the same time. In the exclusive use mode, the relevant physical device is used exclusively by the relevant virtual device.

A column 1304 stores the virtualization type of the relevant virtual server. The virtualization type indicates a virtualization product or a virtualization technique and can clearly distinguish control interfaces or functional differences. Version information may be included. If the relevant virtual server has its own management function, the name of that management function and a management interface may be included. The virtualization type is information about infrastructure and information such as performance and configurable system limits relating to accounting and whether or not it is possible to migrate servers.

A column 1305 stores performance information about the relevant virtual server. The column 1305 is also information about infrastructure.

A column 1306 stores log information. This column 1306 stores information about logs, that is, what kind of information is stored in the logs and where the logs are stored.

A column 1307 stores information about interfaces for operating the log information. This information indicates what type of interface can control what type of information. Marking on the logs as realized by the present invention is enabled by using the information obtained from the column 1306 and the column 1307.

The information about infrastructure is necessary in order to judge whether migration is possible or not when a migration destination of the physical server 102 is to be suggested.

FIG. 14 shows an OS management table 224. The OS management table 224 is a table used to manage information about what kind of an OS 311 is used, how settings are made, what kind of logs are stored, where the logs are stored, and how the logs can be accessed.

A column 1401 stores an OS identifier; and this identifier makes it possible to uniquely identify each OS.

A column 1402 stores a UUID. The UUID is a candidate for the virtual server identifier stored in the column 1401 and is very effective in a wide range of server management. However, any identifier by which the system administrator can identify the relevant server may be used in the column 1401 and there would be no problem unless there are any duplicate identifiers between different servers which are the managed objects. Therefore, it is desirable, but not indispensable, to use the UUID. For example, OS setting information (stored in a column 1404) may be used as the OS identifier in the column 1401.

A column 1403 stores OS setting information. The column 1403 stores, for example, an IP address, a host name, an ID, a password, and a disk image. The disk image indicates a disk image of a system disk that is a processing object of the physical server 102 or the virtual server 2302 which operates on the OS and to which the OS before and after the settings is delivered. The information about the disk image to be stored in the column 1404 may include a data disk.

A column 1405 stores log information. The column 1405 stores information about what kind of information is retained as logs and where the logs are retained.

A column 1406 stores information about interfaces for operating the log information. This information indicates what kind of interfaces can control what kind of information. Marking on the logs as realized by the present invention is enabled by using the information obtained from the column 1405 and the column 1406.

FIG. 15 shows a task management table 225. The task management table 225 is a table used to manage information about what kind of the software resources (for example, the business application 321) are used, what settings are made, what kind of logs are stored, where the logs are stored, and how the logs can be accessed.

A column 1501 stores a task the identifier: and this identifier makes it possible to uniquely identify a task, for example, the business application 321.

A column 1502 stores a UUID. The UUID is a candidate for the virtual server identifier stored in the column 1501 and is very effective in a wide range of server management. However, any identifier by which the system administrator can identify the relevant server may be used in the column 1501 and there would be no problem unless there are any duplicate identifiers between different servers which are the managed objects. Therefore, it is desirable, but not indispensable, to use the UUID. For example, task setting information (to be stored in a column 1504) may be used as the server identifier in the column 1501.

A column 1503 stores the task type, that is, information about software for specifying tasks such as applications and middleware to be used. The column 1503 stores a logical IP address and ID to be used for the relevant task, a password, a disk image, and a port number to be used for the relevant task. The disk image indicates a disk image of a system disk that is a processing object of the physical server 102 or the virtual server 2302 which operates on the OS to which the relevant task before and after the settings is delivered. The information about the disk image to be stored in the column 1504 may include a data disk.

A column 1505 stores log information. The column 1505 stores information about what kind of information is stored in the logs and where the logs are stored.

A column 1506 stores information about interfaces for operating the log information. This information indicates what type of interface can control what type of information. Marking on the logs as realized by the present invention is enabled by using the information obtained from the column 1505 and the column 1506.

FIG. 16 shows a system management table 226. The system management table 226 is a table used to manage the system configuration that is a combination of the physical servers 102, a virtualization mechanism 2301, virtual servers 2302, the OS 331, and the tasks 321 managed by the physical server management table 221, the virtualization mechanism management table 222, the virtual server management table 223, the OS management table 224, and the task management table 225; and also manage system changes, server migration status, and log control.

A column 1601 stores a system identifier; and this identifier makes it possible to uniquely identify a task, for example, the business application 321.

A column 1602 stores a UUID. This UUID may be realized by all the information from the column 1603 to the column 1605 or a combination of parts of the information from the column 1603 to the column 1605, or a unique UUID for this column may be generated. This UUID needs to be unique at least within the range managed by the management server 101.

A column 1603 stores the physical server identifier 1101; a column 1604 stores the virtualization mechanism identifier 1201; a column 1605 stores the virtual server identifier 1301; a column 1606 stores the OS identifier 1401; and a column 1607 stores the task identifier 1501.

Although the attached drawings do not include descriptions about management of racks, floors, plug socket boxes, breakers, centers, existence or no existence of an HA configuration, network infrastructure information, electric power grids, network wire connection relationship, network switches, Fibre Channel switches, capacity of each switch, and network bandwidth, advantageous effects of the present invention can be obtained with respect to system migration across the above-listed elements by managing these elements.

A column 1608 stores system change status. The column 1608 stores the status indicating what is migrated, to where the relevant object is migrated, and whether it is before migration, during migration, or after migration.

A column 1609 stores log acquisition status. The log acquisition status is used to manage whether log acquisition for an object requesting the log acquisition has been completed or not.

A column 1610 stores marking status. The marking status is used to manage whether marking for an object requesting marking on logs has been completed or not. The marking status is an important point for the present invention.

A column 1611 stores log collection status. When logs are collected from an object(s), the log collection status is used to manage whether log collection has been completed or not. When logs are collected into the management server 101, devices outside and inside the BMC 305, or the service processor 801, it is necessary to manage the status.

FIG. 17 shows a trigger event management table 227. In the trigger event management table 227, a column 1701 stores a trigger event identifier. A column 1702 stores the content of the relevant trigger event. In the column 1702, an action of, for example, server migration may be input to the management server 101 or an action of trigger event detection and automatic execution may be input.

In the latter case, an event notice associated with the action becomes a trigger event. Possible trigger events are actions described below. If the columns relating to the system configuration of the system management table 226 are changed, all the changes can be trigger events.

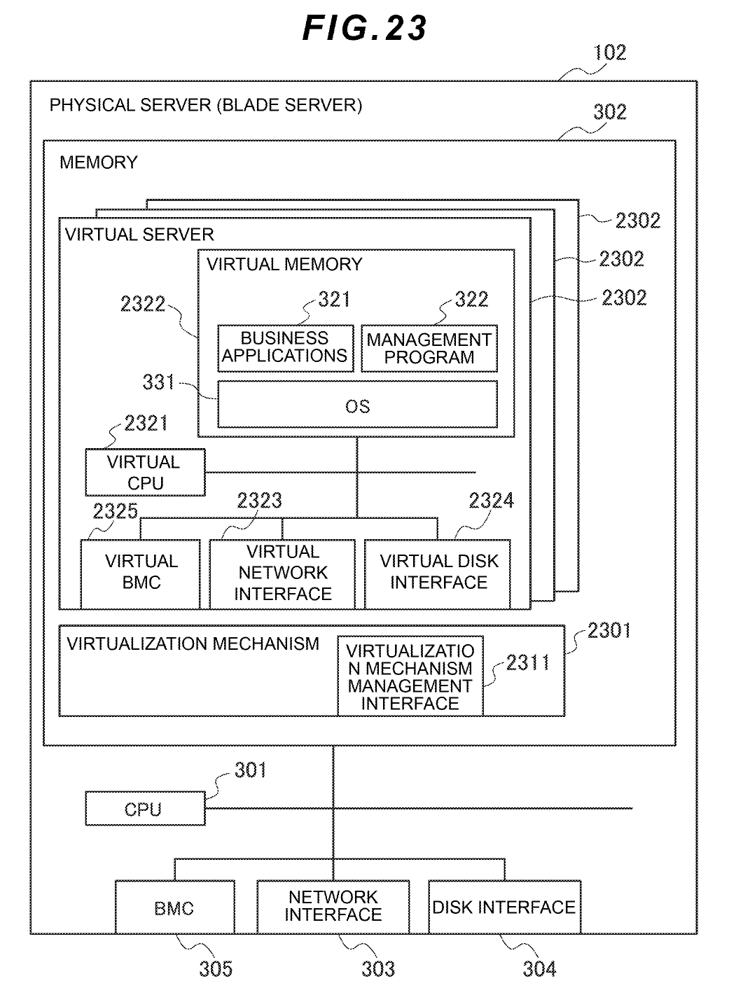

In a case of live migration of a virtual server, the virtual server 2302 and other elements on the virtual server 2302 (the virtual server 2302, the OS 321, and the task 321 [see FIG. 23]) are migrated from (change) the physical server on which they operate, and the operation information log for the physical server 102 is marked. The marking identifier may be any identifier other than that of the physical server 102 and a plurality of identifiers may be used.

If the physical server 102 to which an LU (Logical Unit) is connected is changed, the OS 321 and the task 321 are migrated from the physical server 102, on which they operate, to another physical server 102 and the log operation information log for the physical server 102. The marking identifier may be any identifier other than that of the physical server 102 and a plurality of identifiers may be used.

If the virtual server 2302 to which an LU is connected is changed, the virtualization mechanism 2301 or the virtual server 2302 and other elements thereon (including the OS 321 and the task 321) are migrated, the operation information log for the physical server 102 is marked. The marking identifier may be any identifier other than that of the physical server 102 and a plurality of identifiers may be used.

When a disk image of another task is deployed (delivery or deployment), the same processing is performed as in the case of changing the server to which the LU is connected.

When an eigenvalue (WWN or MAC address) of an interface card is rewritten, the same processing is performed as in the case of changing the server to which the LU is connected.

When the Java (registered trademark) application is deployed, a process (logical server) in the task 321 is added, deleted, or changed. Therefore, identifiers of the task 321 and the process are marked in the operation information log for the physical server 102.

When the IP address of task software is changed, it is possible to regard the physical server 102 or the virtual server 2302 which is operating as being migrated (changed).

In this case, the operation information log for the physical server 102 is also marked. The marking identifier may be any identifier other than that of the physical server 102 and a plurality of identifiers may be used.

When the operation system information is obtained by means of a software activation notice, an OS activation notice, a virtual server activation notice, or a virtualization mechanism activation notice to check if there is any difference from the system management table 226, and if there is a difference between the operation system information and the system management table 226, migration (change) of the physical server 102 occurs. The operation information log for the physical server 102 is marked. The marking identifier may be any identifier other than that of the physical server 102 and a plurality of identifiers may be used.

For example, in the case of migration from the physical server 102, where the software resource exists, to another physical server 102 in the above-described situation, the management server 101 checks if there is any difference between the software resources belonging to the other physical server 102 and the hardware configuration information indicating the configuration to the other physical server 102 on condition that the other physical server 102 is activated. If there is any difference, information indicating the existence of such difference is recorded, together with the identifier, in the log information about the other physical server 102, so that the configuration can be modified to a correct configuration or it is possible to recognize a failure in marking.

In the above-mentioned trigger events, the identifier of the physical server 102 may be marked in an operation log(s) other than that for the physical server 102. Consequently, it is possible to refer to the operation information about the physical server accurately and easily based on the log in which logical operation information (the task 321, the OS 311, the virtual server 2302, the virtualization mechanism 2301) is recorded. The identifier of the physical server 102 may be recorded in all the logs or part of the logs.

When the physical quantity (such as power consumption) of a monitored objects exceeds or falls below a set threshold value, the physical server identifier is marked in log where the logical information is recorded. The measured physical quantity may be marked at the same time. Examples similar to this trigger event include a notice of hardware or software failure information, a performance failure information notice, and a warning (including a failure prediction and a performance failure).

FIG. 18 shows a marking rule management table 228. The marking rule management table 228 is a table used to manage which identifier is marked in what kind of trigger event and in which log.

A column 1801 stores a rule identifier; a column 1802 stores a trigger event identifier (column 1701); a column 1803 stores a hierarchy to be marked; a column 1804 stores a log or log type to be marked; and a column 1805 stores a marking identifier(s).

As a marking method, it is possible to use a means of adding the marking identifier to the latest information part of the relevant log. Also, only the start and end of marking may be added (marking only when the system is changed) and all the logs may be marked later.

FIG. 19 shows an accounting information management table 229. The accounting information management table 229 is a table used to manage information about accounting and suggest a system configuration that will reduce operational costs.

In the accounting information management table 229, a column 1901 stores an accounting information identifier and a column 1902 stores accounting objects. Information to be stored may be the physical quantity such as power consumption, or infrastructure information such as the virtual server or the physical server 102, or SLA (Service Level Agreement) information such as levels of transaction guarantee.

A column 1903 stores conditions to enable the accounting information. Such conditions include time, the system configuration, and infrastructure information (such as existence or no existence and the type of the HA configuration, network bandwidth, and area). A column 1904 stores a unit price.

If reference is made to a log, in which physical operation information is recorded, when using the accounting information management table 229, and if IT equipment such as a server with a high temperature and any facility on which load is imposed are detected when with the accounting information management table 229, it is possible to provide the administrator with more efficient operation (for example, with the effect of lowering the temperature by decreasing the demand for the relevant server and decreasing a coefficient of utilization rate) by operating the conditions and the unit price in the accounting information management table 229 to conduct price manipulation to temporarily increase the price and suppress the demand.

Using the server with a high temperature involves, for the user who uses the computer resources, the high risk of hardware failures due to a rise in temperature. However, it is also possible to avoid the risk of hardware failures due to the temperature by selecting inexpensive computer resources.

FIG. 20 is a flowchart illustrating a processing sequence executed by the trigger event monitor 210.

The trigger event monitor 210 has the CPU 201 for the management server 101 start the processing. The trigger event monitor 210 monitors the occurrence of a trigger event and then judges whether the occurred trigger event should be marked in log or not. If the trigger event is to be marked in the logs, the trigger event monitor 210 gives a command to obtain and mark the logs or collect and mark the logs.

Firstly in step 2001, the management server 101 monitors the occurrence of a trigger event; and if the trigger event occurs, the management server 101 proceeds to step 2002.

In step 2002, the management server 101 refers to the trigger event management table 227 based on the trigger event.

In step 2003, the management server 101 judges, based on the result of reference to the trigger event management table 227, whether to mark the logs or not; and if the management server 101 determines to mark the logs, it proceeds to step 2004; and if the management server 101 determines not to mark the logs, it proceeds to step 2001.

In step 2004, the management server 101 refers to the system management table 226, changes the system management table 226 to indicate that the logs have been marked, and then completes the processing.

Examples of the trigger events include those caused by the user's operation (such as GUI operation or CLI issuance), the occurrence of an event (such as hardware failure information writing and notice), and alert notice (such as notice of exceeding the threshold value and failure notice).

FIG. 21 shows a flowchart illustrating a processing sequence executed by the log acquisition command unit 211.

The log acquisition command unit 211 has the CPU 201 for the management server 101 start the processing. Preconditions for this processing include a judgment by the trigger event monitor 210 to “mark the logs” and reception of a trigger event from the trigger event monitor 210. If the time of the trigger event reception is close to previously set time for a log acquisition trigger event, the log acquisition command unit 211 does not have to give a log acquisition command.

Firstly, in step 2101, the log acquisition command unit 211 refers to the trigger event management table 227.

In step 2102, the log acquisition command unit 211 refers to the system management table 226 based on the result of reference to the trigger event management table 227 and then refers to all of the physical server management table 221, the virtualization mechanism management table 222, the virtual server management table 223, the OS management table 224, and the task management table 225 or only those related to the trigger event or marking of the logs.

Next in step 2103, the log acquisition command unit 211 gives a log acquisition command to the managed objects based on the content of the tables it referred to in step 2102.

Subsequently, the log acquisition command unit 211 updates the system management table 226 in step 2104 and completes the processing.

FIG. 22 is a flowchart illustrating a processing sequence executed by the marking command unit 212.

The marking command unit 212 has the CPU 201 for the management server 101 start the processing. A precondition for this processing is that the logs to be marked and the identifier to be added are decided.

Firstly in step 2201, the marking command unit 212 refers to the marking rule management table 228.

In step 2202, the marking command unit 212 refers to tables which retain the log information to be marked, based on the result of reference to the marking rule management table 228. The marking command unit 212 may refer to all of the physical server management table 221, the virtualization mechanism management table 222, the virtual server management table 223, the OS management table 224, and the task management table 225 or only the tables to be marked.

In step 2203, the marking command unit 212 adds the identifier to the logs to be marked.

In step 2204, the marking command unit 212 updates the system management table 226 based on the content of addition of the identifier to the logs to be marked.

If at least one of the software resources is changed in this embodiment, for example, if the need to migrate the active business application 321 to another physical server arises, the management server 101 extracts the change source or migration source physical server 102, in which the change is made to its software resource or from which the business application 321 is migrated, from among a plurality of physical servers 102; collects, from the extracted migration source physical server 102, the log information (physical operation log)—for example, power information—which has been collected by the migration source physical server 102, and also collects the identifier for identifying the business application 321 operating on the migration source physical server 102, for example, the IP address which is a unique identifier in the computer system; records, for example, the IP address as the collected identifier in the collected power information; and then records (marks) the log information (physical operation log)—for example, power information—about the migration destination physical server (server B) 102 in order to keep a record, in the form of the log information, of migration of the business application 321 to the migration destination physical server (server B) 102.

Therefore, even if the software resource(s) for a physical server is changed, log information about the physical server can be matched accurately against the software resource(s) according to this embodiment. As a result, it is possible to find out the exact amount of the computer resources used.

### Second Embodiment

This embodiment uses a server virtualization technique and also blade servers 802 as physical servers; and other configuration of this embodiment is the same as that of the first embodiment.

FIG. 23 shows the internal configuration of a physical server 102 in the system configuration of the second embodiment which uses the server virtualization technique. In this case, even if a blade server 802 is used as the physical server 102, its internal configuration will be the same.

The blade server 802 is constituted from the CPU 301 for processing arithmetic operations, the memory 302 for storing programs operated by the CPU 301 and data relating to execution of the programs, the disk interface 304 for exchanging information with a storage apparatus storing programs and data, the network interface 303 for external communication via an IP network, and the BMC 305 for power supply control and control of each interface.

The memory 302 is equipped with the virtualization mechanism 2301 for virtualizing computer resources to provide virtual servers 2302. The virtualization mechanism 2301 is also equipped with a virtualization mechanism management interface 2311 as a control interface. The virtualization mechanism 2301 virtualizes the computer resources for the physical server 102 (or the blade server 802) and constitute the virtual servers 2302. Each virtual server 2302 is constituted from a virtual CPU 2321, a virtual memory 2322, a virtual network interface 2323, and a virtual disk interface 2324.

The OS 331 is delivered to the virtual memory 2322 and manages virtual devices in the virtual server 2302. Also, the business application 321 is executed on the OS 331. The management program 322 operating on the OS 331 provides failure detection, OS power supply control, and inventory management.

The virtualization mechanism 2301 manages association between physical devices and logical devices and can associate the physical devices with the logical devices and release the association between the physical devices and the logical devices.

The memory 302 retains configuration information and operation history indicating how many computer resources for the physical server 102 (or the blade server 802) are assigned to and used by which virtual server 2302. It is possible to deduce which virtual server 2302 is engaged in power consumption and how much electric power is consumed, by matching the above-described information and operation logs (such as power consumption logs) retained by the physical server 102 against the logs in which the identifier is marked according to this invention.

As a result, it is possible to identify the virtual server 2303 with highly accurate accounting or particularly high or low power consumption.

The configurations of the control unit 110 and the management table group 111 according to this embodiment are similar to those in the first embodiment.

The software resources in this embodiment are configured so that the virtual servers 2302 are constructed on the virtualization mechanism 2301, the OS 331 is constructed on each virtual server 2302, and the business application 321 is constructed on the OS 331.

Therefore, when the virtualization mechanism 2301 is to be migrated to another physical server 102, the OS 331 and the business application 321, together with the virtualization mechanism 2301, are also migrated to the other physical server 102; and when the virtual server 2302 is to be migrated to another physical server 102, the OS 331 and the business application 321, together with the virtual server 2302, are also migrated to the other physical server 102t; and when the OS 331 is to be migrated to another physical server 102, the business application 321 together with the OS 331 is also migrated to the other the physical server 102; and when the business application 321 is to be migrated to another physical server 102, only the business application 321 is migrated to the other physical server 102.

When this happens, the management server 101 recognizes, for example, migration of the business application 321 as a trigger event and also recognizes the physical server 102 which operates the business application 321, as the change source or migration source physical server 102; and collects, from the migration source physical server 102, the log information (physical operation log)—for example, power information—which has been collected by the migration source physical server 102, and also collects the identifier for identifying the business application 321 operating on the migration source physical server 102, for example, the IP address which is a unique identifier in the computer system.

Next, the management server 101 records, for example, the IP address as the collected identifier in the collected power information and then give a control command associated with the trigger event to the migration source physical server 102 and the migration destination physical server 102. As a result, the business application 321 operating on the migration source physical server 102 is migrated to the migration destination physical server 102.

Subsequently, the management server 101 records (marks), for example, the IP address as the collected identifier in the log information (physical operation log)—for example, power information—about the migration destination physical server 102 in order to keep a record, in the form of the log information, of migration of the business application 321 to the migration destination physical server 102.

As a result, it is possible to find out exactly the observable physical quantity used in the business application 321, for example, electric energy which is power information.

If the business application 321, the OS 331, the virtual server 2302, and the virtualization mechanism 2301 are used as the software resources and any of them is recorded as an object of the software resource change in the log information, the advantages described below will accrue.

If the business application 321 is used as the object of the software resource change, it is possible to find out the status of utilization of the physical computer resources for each business application 321. As a result, when adding the business application 321, it is possible to judge whether the business application 321 should be made to coexist with other business applications on the same OS (virtual server) 331 or should be placed on another OS (virtual server) 331.

It is also possible to judge whether load should be distributed to a physical server 102 which is not the physical server 102 on which the business application 321, the object to be changed, operates, or whether the business application 321 should be migrated to a higher-specification physical server.

If some pieces of software that provides one task are categorized into different levels according to performance and prices, it is possible to select a desired level of software depending on the situation.

If the OS 331 is used as the object of the software resource change, it is possible to find out the status of utilization of the physical computer resources for each OS 331. Specifically speaking, it is possible to view as if the OS 331 has been migrated, by taking over the IP address, the host name, and settings of active tasks. In this way, the OS 331 can easily migrate between different pieces of hardware with different performance; and it is possible to judge whether such migration should be conducted.

It is also possible to conduct migration by deploying a disk image. It takes time to deploy the disk image, but it has the advantages of fewer difficulties in operation and low probability of mistakes as compared to a change of the settings. In this case, it is possible to judge which means is more beneficial to the users.

If the virtual server 2302 is used as an object of the software resource change, it is possible to find out the status of utilization of the physical computer resources for each virtual server 2302. As a result, it is possible to judge whether to carry out migration for each virtual server 2302, or to migrate the components in the hierarchy including the OS 331, or to migrate only the business application 321. The time it takes to dynamically migrate the virtual server 2302 is different from the time it takes to stop the virtual server 2302 once and then migrate it. Even in this case, it is possible to find out the accurate operation information and carry out proper accounting.

If the virtualization mechanism 2301 is used as an object of the software resource change, it is possible to find out the status of utilization of the physical computer resources for the virtualization mechanism 2301. It is possible to use different virtualization mechanisms (with different characteristics such as prices and performance).

Even if the software resource(s) for a physical server is changed, log information about the physical server can be matched accurately against the software resource(s) according to this embodiment. As a result, it is possible to find out the exact amount of the computer resources used.

### Third Embodiment

This embodiment is similar to the first embodiment and the second embodiment, except that whether the log collector 213 operates or not is judged. Specifically speaking, consideration is given to a case where connection to an old system or logs results in a failure to directly edit the logs due to specifications such as an unique interface or due to the viewpoint of keeping independence. If the logs cannot be edited directly, it is necessary to collects the logs via the log collection interface into another server (such as the management server 101) or the service processor 801 and mark the collected logs. Therefore, the log collector 213 is required.

FIG. 24 is a flowchart illustrating a processing sequence executed by the log collector 213.

The log collector 213 has the CPU 201 for the management server 101 start the processing. Firstly in step 2401, the log collector 213 refers to the marking management table 228.

In step 2402, based on the result of reference to the marking management table 228, the log collector 213 refers to the physical server management table 221, the virtualization mechanism management table 222, the virtual server management table 223, the OS management table 224, and the task management table 225 as tables to store the log information to be marked.

In step 2403, the log collector 213 judges, based on the result of reference to each table, whether logs should be collected into other servers (such as the management server 101 and the service processor 801); and if step 2403 returns an affirmative judgment, the log collector 213 proceeds to step 2404; and if step 2403 returns a negative judgment, the log collector 213 terminates the processing.

In step 2404, the log collector 213 gives a command to the managed objects to provide the logs, and then collects the logs.

Subsequently, in step 2405, the log collector 213 updates the system management table 226 and terminates the processing.

Even if connection to an old system or logs results in a failure to directly edit the logs due to specifications such as an unique interface or due to the viewpoint of keeping independence, the logs can be collected into the management server 101 and the service processor 801 via the log collection interface according to this embodiment.

### Fourth Embodiment

The fourth embodiment uses the configurations described in the first embodiment, the second embodiment, and the third embodiment and performs tendency analysis regarding the use of computers for the tasks and the physical server 102. When this tendency analysis is performed, an analysis result or an alert can be given to the users or management software by analyzing the tendencies of whatever observable such the observed physical quantity and the quantity and kinds of operating software and virtual servers in each hierarchy such as a task view, a physical server view, and a virtual server view.

Also, the utilization of more efficient computer resources is supplied to the users by implementing a suggestion on the system configuration based on the result of the above tendency analysis. For example, the suggestion on the system configuration includes a configuration with the best performance within the budget or a configuration of the highest availability, or a combination thereof.

FIG. 25 is a flowchart illustrating a processing sequence executed by the tendency analyzer 214.

The tendency analyzer 214 has the CPU 201 for the management server 101 start the processing. Firstly, the tendency analyzer 214 accepts input regarding an “analyzing view” and “analysis objects” in step 2501. This is the case where the user gives a trigger event. Alternatively, a hardware or software failure notice or a performance failure notice may be a trigger event.

Accordingly, if the current configuration would interfere with the operation of tasks or the operation within the budget, the users can easily and promptly find out the cause analysis results and the system configuration that would be the prevention measures; and the users can also easily implement the measures.

Next, the tendency analyzer 214 judges the view in step 2502.

In step 2503, the tendency analyzer 214 refers to the system management table 226.

In step 2504, based on the result of reference to the system management table 226, the tendency analyzer 214 refers to the physical server management table 221, the virtualization mechanism management table 222, the virtual server management table 223, the OS management table 224, and the task management table 225 as tables to store the operation information.

In step 2505, based on the result of reference to each table, the tendency analyzer 214 extracts parts which are judged by the analyzing view to be marked, from the logs which are analysis objects.

In step 2506, the tendency analyzer 214 outputs the analysis result and completes the processing.

If the current configuration would interfere with the operation of tasks or the operation within the budget, this embodiment makes it possible for the users to easily and promptly find out the cause analysis results and the system configuration that would be the prevention measures; and the users can also easily implement the measures.

FIG. 26 is a flowchart illustrating a processing sequence executed by the system configuration suggesting unit 215.

It is possible to suggest: a system configuration that would minimize the electric power usage; a system configuration that would minimize the space usage; and a system with high performance or availability within the budget if there is a difference in the usage or rates between day and night.

For example, it would be ideal if a high-performance and highly available system is obtained at a low price; however, in fact, systems with higher added values are more expensive. Also, there is an upper limit of the user's budget and it is necessary to compromise the ideal conditions and the budget limit.

Examples of use limits include budgets, power consumption upper limit, CPU usage upper limit and lower limit (desirable to use at _% or more), upper limit of the memory usage, upper limit of the network bandwidth usage, network infrastructure (_ Gbps or more), upper and lower limits of throughput of the business application 321, exclusive use or sharing of the computer resources, and the existence or no existence, and types of the HA configuration.

The system configuration suggesting unit 215 has the CPU 201 for the management server 101 start the processing. Firstly, the system configuration suggesting unit 215 accepts inputs regarding “physical quantity to be minimized or maximized” (the physical quantity serving as an evaluation standard) and “preconditions” (limit values) in step 2601.

In step 2602, the system configuration suggesting unit 215 refers to the accounting information management table 229 and the system management table 226.

In step 2603, the system configuration suggesting unit 215 changes the system configuration within the range of the preconditions based on the result of reference to the tables.

In step 2604, the system configuration suggesting unit 215 judges whether the physical quantity which serves as the evaluation standard is minimum or maximum. Whether the physical quantity is minimum or maximum changes depending on what is set as a condition to satisfy. It is not that the physical quantity may be either minimum or maximum. If the physical quantity is minimum or maximum, the system configuration suggesting unit 215 proceeds to step 2605; and if step 2604 returns a negative judgment, the system configuration suggesting unit 215 proceeds to step 2606.

In step 2605, the system configuration suggesting unit 215 stores the system configuration and deemed physical quantity. The system configuration suggesting unit 215 uses these values in step 2604.

In step 2606, the system configuration suggesting unit 215 checks if all the trials have been completed. If all the trials have been completed, the processing proceeds to step 2607; and if all the trials have not been completed, the processing proceeds to step 2603.

In step 2607, the system configuration suggesting unit 215 outputs the retained system configuration and deemed physical quantity and then completes the processing.

The system configuration suggesting unit 215 sends an alert notice of the output result to the management server 101, and the management server 101 gives a command to change the configuration. As a result, even if the administrator is absent, it is possible to solve the problems. Alternatively, the configuration change may be executed not automatically, but after waiting for the user's judgment and receiving their approval.

According to the present invention, it is possible to suggest: a system configuration that would minimize the electric power usage; a system configuration that would minimize the space usage; and a system with high performance or availability within the budget if there is a difference in the usage or rates between day and night.

In each embodiment, instead of recording an identifier in the log information, a UUID may be generated and the generated UUID may be recorded in the log information. In this case, the marking subject may generate and record the UUID, or the management server 101, the BMC 305, or the service processor 801 may generate and record the UUID.

Furthermore, when recording the identifier in the log information in each embodiment, it is possible to recognize the log information in association with time by obtaining time of the physical server 102 relating to migration or time of the management server 101 and recording the obtained time in the log information. In this case, more accurate matching is enabled by using the marking time or the time recorded in the logs, rather than using time obtained as a result of making inquiry.

Furthermore, when recording an identifier in the log information in each embodiment, more accurate matching is enabled by adding and marking the identifier that shows a history of migration of the software resource. For example, if the software resource has been migrated between the physical servers 102 having the same configuration recently (for example, according to the user's setting or a default setting such as “within 10 minutes”), it is possible to accurately recognize the second or any subsequent migration of the software resource by referring to the identifier indicating the history of the migration of the software resource.

Furthermore, the management server 101 is the subject of actions in each embodiment. However, the advantageous effects of the invention can be achieved even if the physical server 102, the blade server 802, the service processor 801, the virtualization mechanism 2301, or the virtual server 2302 is the subject of actions and retains the control unit and the management table group.

What is claimed is:

1. An operation information management method for a computer system comprising a plurality of physical servers for operating at least one software resource and collecting log information, and a management server connected via a network to the plurality of physical servers for managing each of the physical servers,
wherein the operation information management method comprising the following steps executed by the management server of:
before a change to be made to any software resource, from among the software resources operating on each physical server, to have the software resource operate on another physical server, recording an identifier for identifying the software resource operating on a change source or migration source physical server in which the change is made to the software resource, from among the physical servers, in log information about the change source physical server on which the software resource operates before the change; and
recording the identifier in log information about the other physical server after the change.

2. The computer system operation information management method according to claim 1, further comprising the steps executed by the management server of:
collecting the log information from the change source physical server and the log information from the other physical server, respectively; and
recording the identifier in each piece of the log information collected respectively in the above step.

3. The computer system operation information management method according to claim 1, further comprising the following steps executed by the management server of:
collecting the log information from the change source physical server and the log information from the other physical server, respectively;
recording the identifier in each piece of the log information collected respectively in the above step; and
when recording the identifier in the log information in the above step, recording a history for specifying the identifier in the log information.

4. The computer system operation information management method according to claim 1, wherein the change is migration of the software resource belonging to the migration source physical server to the other physical server.

5. The computer system operation information management method according to claim 1, wherein the change is a change of the physical server in order to have the software resource, which operates on the migration source physical server, operate on the other physical server.

6. The computer system operation information management method according to claim 1, further comprising the following steps executed by the management server of:
judging, on the condition of activation of the other physical server, whether or not there is a difference between software resources belonging to the other physical server and hardware configuration information indicating the configuration of the other physical server; and
if there is the difference as a result of the judgment in the above step, recording information to that effect together with the identifier in the log information about the other physical server.

7. An operation information management method for a computer system comprising a plurality of physical servers for operating at least one software resource and collecting log information, and a management server connected via a network to the plurality of physical servers for managing each of the physical servers,
wherein the operation information management method comprising the following steps executed by the management server of:
collecting the log information from each physical server;
treating an event where any log information from among the pieces of log information collected in the above step exceeds or falls below a predetermined threshold value, as a trigger event and recording an identifier for identifying a software resource operating to collect the log information, which exceeds or falls below the threshold value, or recording the log information value which exceeds or falls below the threshold value, in log information about a physical server from which the log information which exceeds or falls below the threshold value is collected.

8. The computer system operation information management method according to claim 1, wherein the software resource is a business application.

9. The computer system operation information management method according to claim 1, wherein the software resource is an operating system.

10. The computer system operation information management method according to claim 1, wherein the software resource is a virtual server.

11. The computer system operation information management method according to claim 1, wherein the software resource is a virtualization mechanism.

12. The computer system operation information management method according to claim 1, wherein the software resources are a virtualization mechanism for virtualizing hardware resources for the physical servers, virtual servers virtualized by the virtualization mechanism, an operating system operating on the virtual servers, and business applications operating according to the operating system.

13. The computer system operation information management method according to claim 1, wherein the software resources are constituted from a virtualization mechanism for virtualizing hardware resources for the physical servers, virtual servers virtualized by the virtualization mechanism, an operating system operating on the virtual server, and business applications operating according to the operating system, and the change to be made to have the software resource operate on another physical server is a change in at least one of the virtualization mechanism, the virtual server, the operating systems, and the business applications.

14. A computer system comprising a plurality of physical servers for operating at least one software resource and collecting log information, and a management server connected via a network to the plurality of physical servers for managing each of the physical servers,
wherein before a change to be made to any software resource, from among the software resources operating on each physical server, to have the software resource operate on another physical server, the management server records an identifier for identifying the software resource operating a change source or migration source physical server in which the change is made to the software resource, from among the physical servers, in log information about the change source physical server on which the software resource operates before the change; and
the management server records the identifier in log information about the other physical server after the change.

15. The computer system according to claim 14, wherein the management server collects the log information from the change source physical server and the log information from the other physical server, respectively; and records the identifier in each piece of the log information collected respectively above.

16. The computer system according to claim 14, wherein the change is migration of the software resource belonging to the migration source physical server to the other physical server.

17. The computer system according to claim 14, wherein the change is a change of the physical server in order to have the software resource, which operates on the migration source physical server, operate on the other physical server.

18. The computer system according to claim 14, wherein the management server judges, on the condition of activation of the other physical server, whether or not there is a difference between software resources belonging to the other physical server and hardware configuration information indicating the configuration of the other physical server; and
if there is the difference as a result of the judgment in the above step, the management server records information to that effect together with the identifier in the log information about the other physical server.

19. The computer system according to claim 14, wherein the software resources are a virtualization mechanism for virtualizing hardware resources for the physical servers, virtual servers virtualized by the virtualization mechanism, an operating system operating on the virtual server, and business applications operating according to the operating system.

20. The computer system according to claim 14, wherein the software resources are constituted from a virtualization mechanism for virtualizing hardware resources for the physical servers, virtual servers virtualized by the virtualization mechanism, an operating system operating on the virtual server, and business applications operating according to the operating system, and the change to be made to have the software resource operate on another physical server is a change in at least one of the virtualization mechanism, the virtual servers, the operating system, and the business applications.
